(19) United States
(12) Patent Application Publication
(10) Pub. No.: US 2021/0261250 A1
(43) Pub. Date: Aug. 26, 2021

(54) CLEANING DIFFICULT TO REACH STRUCTURES USING DRONES

(71) Applicant: Iulian Cioanta, Milton, GA (US)

(72) Inventors: Iulian Cioanta, Milton, GA (US); John Jackson, Buford, GA (US)

(73) Assignee: Iulian Cioanta, Milton, GA (US)

(21) Appl. No.: 17/180,626

(22) Filed: Feb. 19, 2021

Related U.S. Application Data
(60) Provisional application No. 62/979,952, filed on Feb. 21, 2020.

(51) Int. Cl. B64C 39/02; B08B 5/02; E04D 13/076; B64D 45/00

(52) U.S. Cl. CPC B64C 39/024; B08B 5/02; B64C 2201/12; B64D 45/00; E04D 13/0765

(57) ABSTRACT

A drone system includes a drone aircraft connected to an air duct that terminates in a nozzle that emits a jet of air with a blowing force from the blower nozzle, such as for cleaning tall and hard to reach surfaces of structures and buildings or to otherwise blow objects, debris, substances and floating materials.

### CROSS-REFERENCE TO RELATED APPLICATIONS

This application claims the benefit of priority of U.S. provisional application No. 62/979,952, filed Feb. 21, 2020, which is incorporated herein by reference.

### BACKGROUND OF THE INVENTION

In general, a clean and well-maintained building makes an impression even before a visitor gets inside. The same can be said about monuments, bridges, billboards, large aircrafts, ships, buses, large trucks, etc. This is why the cleaning is necessary for our modern society. Furthermore, such cleaning has also the role to maintain these structure and crafts, to prolong their useful life by preventing degradation. Sometimes cleaning is used to maintain a good functionality. Such examples are satellite dishes, silos, chimneys, elevator shafts, solar panels, mine shafts, etc.

There are different methods of cleaning, depending on what structure, monument, craft, or object is cleaned. There was a progressive evolution from methods that could clean and in the same time produce some moderate damage, to more friendly methods in reference to the structure/craft/object integrity and the use of friendly environmental materials for cleaning.

As of 2018, there are nearly 138.45 million housing units in the United States. The common home has an average of 200 feet of gutters, which need to be cleaned at least twice a year. These routine maintenance tasks are essential for protecting a homeowner's investment and overall health. Cleaning gutters protects against roof and structural damage; prevents dampness, mold and water damage; and avoids pest infestation. Removing debris from gutters and roofs is no longer limited to just the use of power washers, climbing on the roof and use normal leaf blowers, handheld rakes and the hands. A rising trend affecting the market involves the adoption of smart technology. Vacuum cleaners that can reach up to 4 stories safely from the ground using a strong vacuum and carbon fiber poles that fit together and have advanced features that heighten cleaning efficiency. Other mechanical access tools and extensions can eliminate the climbing on the roofs. There also are a myriad of gutter guard brands to prevent clogging that fail to deliver on expectations and at their turn need cleaning from time to time.

Since some houses are more challenging than others, most gutter cleaners work in pairs. Traditional gutter cleaners carry long ladders and do not fear climbing on roofs to blow leaves, pine needles, sticks and dirt out of the gutters with a handheld or backpack blower. Traditional gutter cleaning is very physical. This is typically a speedy but very dangerously process. Approximately 90,000 people are hospitalized annually in the USA due to falling off ladders. These professionals need specific insurance policies to cover gutter cleaning and no matter how experienced the gutter cleaner, one misstep or slip and it could wreck the business. Everyone is being sued including the homeowner. The insurance company is dropping their policy and they are having a rough time getting another policy. This might put them out of the gutter cleaning business altogether. As large as the demand for clean gutters is for the American home and property owner, the American gutter industry is awash in untrained and uninsured general contractors who earn extra income by offering gutter cleaning.

Lately, gutter-guard systems have invaded the market with different grades of success. These systems have the tendency to keep humidity inside the gutters and in time develop fungi, molds, mildew, algae, and biofilms that gives an unpleasant view of the roof in general due to different dark color patches/stains of fungi, molds, algae, and biofilms formed on gutters. Furthermore, the fungi, molds, mildew, algae, and biofilms will clog/foul the holes used for water drainage and reduces their functionality. Finally, regardless of the design, in time leaves or dirt or pine needles or sticks are caught in their water drainage holes. Based on all the above-mentioned factors, all the gutter-guard systems in time still need periodic cleaning, although as not often as the open gutters. Their cleaning is even more challenging, since the integrity and functionality of the gutter-guard systems must be kept, to avoid any damages, since they are expensive to buy and install.

In general, patents issued for gutter cleaning teach about cleaning using pressurized water from a garden hose (U.S. Pat. No. 4,673,129), complicated devices that have fork-like jaws (U.S. Pat. No. 4,930,824), rotating auger screw (U.S. Pat. No. 6,185,782), robotic systems (U.S. Pat. Nos. 7,886,399 and 8,196,251), air blower at the upper end of a pole (U.S. Pat. No. 8,510,910), vacuum cleaning system (U.S. Pat. No. 5,195,209) and many other variations of the above-mentioned systems. The disclosures of these referenced patents are incorporated herein by reference.

It is preferred to clean not only what is visible, but also the organic fouling (bacteria, fungus, algae, etc.), and debris that is unknowingly growing in the gutters. The industry needs a new approach that is safe for the worker making the gutter cleaning, but also to be efficient in cleaning and easy to be done, without exposing any of the parties to unnecessary liabilities. The technology preferably preferable is able to be the eyes in the sky, without having to get workers on the roof, which can expose the roofing company and the house owner to risk of accidents and damage to the roof. For that, the use of a drone system remotely operated from the ground is the answer. Such drone system can generate gentle jets of air able to efficiently remove the debris from the gutters, while avoiding material damage to the roof and gutters and without having the liability to put operators on the roof. Furthermore, a cleaning drone system can eliminate the use of cumbersome systems that cannot clean efficiently and could become a danger to the operator, even if such person is not required to climb a ladder or be on the roof. The reduced liabilities associated with the cleaning using a drone system, can results in significant cost reduction for the homeowner. With such drone systems there are no limitations on the height of the building or how complicated the gutter system might be. The drones have live-cameras that can be used to assess the cleaning process efficiently and adapt the cleaning based on the particular situation observed on the camera. Thus, based on the grade/quantity of unwanted material deposit and soiling/fouling shown on live-camera, the thrust of air and substances provided by the drone can be adjusted to accomplish a proper and gentle cleaning. Furthermore, such drone systems can be used to inspect the roof, chimneys or any other home structures, by remotely operating them from the ground. Also, the whole cleaning operation can be made in a shorter time, which allows the operator of the drone cleaning system to generate more revenue during one working day. These advantages might open the door for changing from a cleaning process towards a maintenance process (more than two cleanings per year), which will improve the overall functionality of the gutters and maintain their integrity and reduce their contamination. In fact, such maintenance service can be part of normal lawn, landscaping, and house maintenance programs, due its financial viability and elimination of liabilities.

Historic buildings and monuments can be also subject to accumulation of dust, and other materials that produce stains and biofilm formation, which can destroy the general aesthetic aspect of the building or monument. For such historic buildings and monuments, the cleaning work could involve periodic cleaning of roofs, windows, masonry in general, and detailed features based on each monument design and structure. Cleaning preferably is undertaken only when dirt or other deposited material obscures significant architectural or monument features or if it is causing or has the potential to cause damage to masonry and monument materials. Roof cleaning for historic buildings is the process of removing any material accumulation from it. The presence of soot, dirt, or biomass can affect how much sunlight a roof absorbs and thus the amount of heat a building absorbs. Historic windows are among the most important features in defining a building or structure's character, and proper treatment is extremely important. Such windows preferably are periodically inspected and properly cleaned and maintained.

Today the most used methods to clean such buildings and monuments employ abrasive cleaning methods that are responsible for causing a great deal of damage to materials incorporated in such structures. However, before any cleaning careful testing preferably is done to assure that the method selected will not have an adverse effect on the building materials giving the fact that a historic building is irreplaceable. The cleaning methods for historic buildings and monuments preferably is carefully selected to do the job without harming the historic material. Up to now, only non-acidic neutral pH detergents are recommended (see U.S. Pat. No. 6,090,766 (disclosure of which is incorporated herein by reference)) in conjunction with non-metallic brushes or scrapers. Water pressure for cleaning should preferably not exceed 150-200 psi since higher pressures can damage historic masonry units and mortar.

For very tall buildings, the cleaning of the windows, metal, concrete is the process of cleaning a building's exterior, including the restoration of good hygiene or removal or prevention of litter, dirt, mildew, stains, molds, fungi, algae, or biofilms. The exterior cleaning draws on aspects of environmental care, architecture preservation, and psychological well-being. To clean such tall buildings special supported scaffolding can be used, which creates temporary platform for workers to stand. Another option is given by suspended platforms or cradles, which are hold by wire rope from above. They raise and lower the worker either by hand or with a motor. Aerial work platforms are also used, which are platforms that workers can stand on, and they are raised via a scissor lift, or cherry picker. For all these solutions there are tight restrictions to prevent the use of excessive water—and also on the way the water is safely fed to heights up to 60 ft. More recently, the high tech fully automated robotic window cleaners are starting to become common for cleaning of commercial and industrial buildings, and also for houses. Robotic cleaners use fans, vacuum or magnets to stay firmly attached to glass, while cleaning windows and squeegeeing them dry as they move on.

Each industry, from manufacturing to refining and power generation, has several tall structures that are unique. Cleaning of such industrial tall structures is done by highly trained and equipped individuals, to manage all applications from inspections to repairs and maintenance. Whether inside or outside of large structures, the traditional approach is the use of rope access to allow the execution of tough tasks in difficult-to-reach locations. Such structures are utility power plant chimneys, paper mill stacks, industrial chimney cleaning, marine smokestacks, rigging and lifting, bridges, dams, lighthouses, radio towers, landmark signage, large wind power turbines, and church steeples. Each job is different from another due to specificity and complexity of such industrial structures. A lot of safety measures need to be taken and the liability is high for such jobs that necessitate highly insured individuals, which in the end increases the cost of the operations.

Accordingly, there is a need for improved cleaning systems for residential buildings or tall buildings, or large structures, or hard to reach places, such as via drone systems of embodiments of the invention described herein, to reduce risks and costs associated with conventional cleaning methods

### SUMMARY OF THE INVENTION

To improve upon prior cleaning methods, embodiments of the invention provide for use of a drone system that can generate jets of air oriented towards a targeted surface that needs to be cleaned, without producing damage to the surface and is also environmentally friendly. In embodiments, systems of the invention are controlled from the ground and thus do not need an operator to climb a structure to produce the cleaning, which can generate accidents and potential liabilities for the operator and the beneficiary of the respective services. Drones have cameras, which allows continuously the monitoring of the cleaning with the operator just sitting on the ground. Such drone system can be used to clean gutters, historic buildings, monuments, silos, tall buildings and high rises, bridges, dams, church steeples, radio towers, solar panels, large satellite dishes or telescopes, gondola lifts, billboards and large signs, chimneys, large aircrafts and ships, space crafts or rockets and launching pads, busses and large trucks, large earth-moving equipment, elevator shafts, large pipes and ducts, mine shafts, large storage containers (water, oil, chemicals, etc.), shipping containers, stadiums or sport venues on the inside and outside, special large roofs, the inside of buildings or theaters or museums that have large atriums, and other similar structures to name a few. Similar embodiments can be used to blow objects (in air, on land or on water), debris (in air, on land or on water), substances (in air, on land or on water), or materials floating on water (e.g., lakes, rivers, ocean and like bodies).

An embodiment of the present invention includes a drone system that uses a vent to produce jets of air for cleaning. It is known that normal/light (conventional) drones have limited capacity to carry weight and this is why there are challenges on having a structure, even if relatively light attached to the drone, while also only using the limited energy produced by the drone's battery. The jets of air in an embodiment of the invention can be produced using a dedicated light blower system that can be attached to a drone, or by collecting the down draft/kinetic energy from some of the propellers of the drone. These approaches have their own challenges and solutions for addressing the same are described in various embodiments of the present invention.

If the drone system can lift larger weights, then besides blowing air the drone can be capable of injecting fluid in the air stream or use other energy devices that can enhance the cleaning effect. The fluid can be water by itself or mixed with biocides, active detergents, cleaning substances, or special chemicals, which are environmentally friendly and are dissolved in the respective fluid, creating different mixtures that are used for removing stains, molds, algae, fungi, mildew, biofilms, etc. The energy devices preferable used to enhance cleaning are ultrasound piezo crystals that produce sound waves or shock waves transmitted through the liquid mist expelled from the system nozzle, or photodevices as lasers, or infrared-light LEDs (light emitting diodes)/OLEDs (organic light emitting diodes), or ultraviolet light lamps, etc. For such drones, additional batteries can optionally be added to prolong their active period of service. The fluid jet sources, or other energy devices, can be made independently active or inactive, and can be directed/oriented to provide a focused area of cleaning on a fouled surface, in order to facilitate the removal of soot, dirt, biomass or other materials accumulation. The control of the drone is done via the software that comes with the drone or through a modified software that uses the same hardware that the drone is originally equipped with.

Embodiments of the invention provide special designs for the accessory/accessories that is/are necessary to be attached to the drone system in order to perform specific tasks targeted by this invention, such as the cleaning of difficult to reach structures while at the same time providing intricate, delicate and gentle cleaning, so as not to damage the structures. This invention also relates in embodiments to specific construction and structure of the drones, their way of operating, their associated software configurations and functionality.

### BRIEF DESCRIPTION OF THE DRAWINGS

FIG. 1A is a front perspective view from above of an embodiment of the invention including a drone that fully collects the thrust from two of its propellers via a conical funnel and guides the air stream towards a central nozzle that directs the resulting jet of air towards a surface that needs gentle cleaning while avoiding material damage.

FIG. 1B is a right-side perspective and partial cross-sectional view from above of the embodiment of FIG. 1A, wherein the conical funnel that fully collects the thrust of the propeller is shown in a partial cross section to additionally show the drone system functionality.

FIG. 1C is a right-side view of the embodiment of FIGS. 1A and 1B.

FIG. 1D is a top view of the embodiment of FIGS. 1A, 1B, and 1C.

FIG. 1E is a bottom view of the embodiment of FIGS. 1A, 1B, 1C, and 1D.

FIG. 2A is a front perspective view from above of an embodiment of the invention of a drone that has an external cylindrical thrust collector and a central conical funnel that partially collects the thrust from two of its propellers and guides the air stream towards a central nozzle that directs the resulting jet of air towards a surface that needs gentle cleaning while avoiding material damage.

FIG. 2B is a right-side perspective and partial cross-sectional view from above of the embodiment of FIG. 2A, wherein the external cylindrical thrust collector and conical funnel that partially collects the thrust of the propeller are shown in a partial cross section to additionally show the drone system functionality.

FIG. 2C is a right-side view of the embodiment of FIGS. 2A and 2B.

FIG. 2D is a top view of the embodiment of FIGS. 2A, 2B, and 2C.

FIG. 2E is a bottom view of the embodiment of FIGS. 2A, 2B, 2C, and 2D.

FIG. 3A is a front perspective view from above of an embodiment of the invention of a drone that uses a dedicated blower to produce and guide via an air nozzle a jet of air towards a surface that needs gentle cleaning while avoiding material damage.

FIG. 3B is a right-side perspective and partial cross-sectional view from above of the embodiment from FIG. 3A, wherein the blower, the associated duct, and nozzle are shown in a partial cross section to additionally show the drone system functionality.

FIG. 3C is a right-side view of the embodiment of FIGS. 3A and 3B.

FIG. 3D is a top view of the embodiment of FIGS. 3A, 3B, and 3C.

FIG. 3E is a bottom view of the embodiment of FIGS. 3A, 3B, 3C, and 3D.

FIG. 3F is a left side perspective view of the embodiment of FIG. 3A, where the drone includes a dedicated fluid reservoir and an energy device to produce a jet of air mixed with a fluid mist that transfers ultrasound or shock waves towards a surface to enhance its gentle cleaning while avoiding material damage.

FIG. 3G is a left side view of the embodiment of FIG. 3F.

FIG. 3H is a front view of the embodiment of FIGS. 3F and 3G.

FIG. 3I is an isolated view of an energy device of the drone system of the embodiment of FIGS. 3F, 3G, and 3H, showing the energy device attached to the nozzle that generates ultrasound or sound waves or shock waves to enhance the targeted surface gentle cleaning while avoiding material damage.

FIG. 3J is an isolated view of an alternative energy device in an alternative embodiment of the drone system of FIGS. 3F, 3G, and 3H, showing the alternative energy device attached to the nozzle that generates ultrasound or shock waves and also generates photo-energy produced by lasers, infrared-light LEDs (light emitting diodes)/OLEDs (organic light emitting diodes), or ultraviolet light lamps, to enhance the targeted surface gentle cleaning while avoiding material damage.

FIG. 3K is a rear view of the embodiment of the drone system of FIGS. 3F, 3G, 3H, 3I, and 3J.

FIG. 4 illustrates multiple views of an “extra air” nozzle as an alternative to the nozzle of the drone systems shown in FIGS. 1A through 3E, in which the “extra air” nozzle collects more air via intake openings.

FIG. 5 is a schematic diagram of a drone controller structure in an embodiment of the invention to produce a jet of air via an air nozzle for directing air towards a surface that needs gentle cleaning while avoiding material damage, such as may utilized in drone systems according to the embodiments presented in FIGS. 1A through 4.

### DETAILED DESCRIPTION OF THE INVENTION

The use of drone system in embodiments of the invention, particularly including a camera attached to the drone, which is remotely operated from the ground, can be initially used to inspect the potential damage to a building structure, including historical buildings and monuments. Afterwards, the same drone system can be used to clean historic buildings and monuments using jets of air specifically oriented towards the targeted surface that can gently remove the soot, dirt, biomass or other materials accumulation, before using other deep cleaning methods, if necessary, or starting the restoration of such historic buildings or monuments. By using a drone system for the initial inspection/cleaning of a historic building or monument, cleaners can avoid the use of large scaffolding and the expense associated with it. Furthermore, the fact that the drone operator stays on the ground without the necessity to climb the building or the monument reduces the potential liability and insurance associated with it. With such drone systems there are no limitations on the height of the building or monument. The drones also have live-cameras that can be used to assess the cleaning process efficiently and adapt the cleaning based on the particular situation observed on the camera. Thus, based on the grade/quantity of unwanted material deposit and soiling/fouling shown on live-camera, the thrust of air and substances provided by the drone can be adjusted to accomplish a proper and gentle cleaning.

In preferred embodiments, drones have collision sensors to avoid any contact with the cleaned surface and thus eliminate any potential damage. Together, the improvements of the invention allow the whole cleaning operation of historical monuments and buildings to be made in a safer way and shorter time.

Silo cleaning is a process necessary to maximize the functional efficiency of storage silos that hold bulk powders or granules. In silos, material is fed through the top and removed from the bottom. Typical silo applications include animal feed, industrial powders, cement, and pharmaceuticals. Free movement of stored materials, on a first-in, first-out basis, is essential in maximizing silo efficiency. The goal of silo functional efficiency is to ensure that oldest material is used first and does not contaminate newer, fresher material. Two main problems complicate silo efficiency, which are the rat holing and bridging. When rat holing occurs, powders adhere to the sides of silos. Bridging occurs when material blocks at the silo base. Manual cleaning, by lowering a worker on a rope to free material, is the simplest way to clean silos. However, manual cleaning is dangerous due to the release of material and the possible presence of accumulation of gases. In cases of bridging, an additional danger exists as the exit hole needs to be rodded from underneath, exposing the worker to falling powder. By using a drone system, as in the present invention, for inspection and cleaning of a silo can avoid the drop via a rope of the worker inside the silo and potential use of large scaffolding and the expense associated with it. Furthermore, the fact that the drone operator stays on the ground outside the silo structure without the necessity to climb the silo and to be roped from the top inside a toxic environment avoids potential liability and insurance associated with it. With such drone systems there are no limitations on the height of the silo and because drones have live-cameras the cleaning process is efficient and adaptable based on the particular situation observed on the camera. Thus, based on the grade/quantity of unwanted material deposit and soiling/fouling shown on live-camera, the thrust of air and substances provided by the drone can be adjusted to accomplish a proper and gentle cleaning. In preferable embodiments, drones have collision sensors to avoid any contact with the cleaned surface and thus eliminate any potential damage. Together, the improvements of the invention provide for the whole inspection and cleaning operation of a silo to be made in a safer way and shorter time.

Using a drone system of the invention for inspection and cleaning of a tall building can avoid the use of special scaffolding and platforms and the expense associated with it. The drone operator stays on the ground and avoids having workers climbing or being suspended at high heights, which exposes them to unexpected winds, slippages, and other hazards, and thus sidestepping the potential liability and insurance associated with such high-risk jobs. With a drone system, there are no limitations on building height and because the drones have live-camera the cleaning process is efficient and adaptable based on the particular situation observed on the camera. Thus, based on the grade/quantity of unwanted material deposit and soiling/fouling shown on live-camera, the thrust of air and substances provided by the drone can be adjusted to accomplish a proper and gentle cleaning. In preferable embodiments, drones preferably have collision sensors to avoid any contact with the cleaned surface and thus eliminate any potential damage. Together, the improvements of the invention provide for the whole cleaning operation of tall buildings to be made in a safer way and shorter time.

Drone systems in embodiments of the invention for inspection and cleaning of tall structures avoids the use of specialized and expensive scaffolding and other complicated equipment, and in the end reduces the cost of the cleaning. The drone operator stays all the time on the ground and thus it is avoided the necessity to have workers climbing or being suspended at high heights on intricated structures, which expose them to multiple hazards. In this way the potential liability and insurance associated with such high-risk jobs are circumvented. With a drone system, there are no limitations on structure height and because the drones have live-camera the cleaning process is efficient and adaptable based on specific situation observed on the camera. Thus, based on the grade/quantity of unwanted material deposit and soiling/fouling shown on live-camera, the thrust of air and substances provided by the drone can be adjusted to accomplish a proper and gentle cleaning. In preferable embodiments, drones have collision sensors to avoid any contact with the cleaned surface and thus eliminate any potential damage. Together, the improvements of the invention provide for the whole inspection and cleaning operation of special tall structures to be made in a safer way and shorter time.

Solar panels (roof or solar panels from large photovoltaic solar panels) absorb sunlight as a source of energy to generate direct current electricity. A photovoltaic module is a packaged, connected assembly of photovoltaic solar cells available in different voltages and wattages. Photovoltaic modules constitute the photovoltaic array of a photovoltaic system that generates and supplies solar electricity in commercial and residential applications. Ground-mounted photovoltaic systems are usually large, utility-scale solar power plants. Their solar modules are held in place by racks or frames that are attached to ground-based mounting supports. To increase efficiency solar trackers can be used to increase the energy produced per module at the cost of mechanical complexity and increased need for maintenance. The solar trackers sense the direction of the Sun and tilt or rotate the modules as needed for maximum exposure to the light. Alternatively, fixed racks hold modules stationary throughout the day at a given tilt (zenith angle) and facing a given direction (azimuth angle). Tilt angles equivalent to an installation's latitude are common. Some systems may also adjust the tilt angle based on the time of year. To maximize total energy output, modules are often oriented to face south (in the Northern Hemisphere) or north (in the Southern Hemisphere). Roof-mounted solar power systems consist of solar modules held in place by racks or frames attached to roof-based mounting supports. Solar panels conversion efficiency, typically in the 20% range, is reduced by dust, grime, pollen, and other particulates that accumulate on the solar panel. Furthermore, a dirty solar panel can reduce its power capabilities by up to 30% in high dust/pollen or desert areas. Therefore, a drone system that is used to continuously or periodically cleaning solar panels, maintains their full capacity to produce electricity. The drone operator stays all the time on the ground and coordinates the cleaning from the distance, avoiding unnecessary hazards. Usually, such solar panels are periodically washed to maintain their efficiency and by eliminating such water cleaning, will reduce the actual cost of the operation and removes the use of significant amount of water that has environmental benefits. With a drone system, there are no limitations on building height and because the drones have live-camera the cleaning process is efficient and adaptable based on specific situation observed on the camera. Thus, based on the grade/quantity of unwanted material deposit and soiling/fouling shown on live-camera, the thrust of air and substances provided by the drone can be adjusted to accomplish a proper and gentle cleaning. In preferable embodiments, drones have collision sensors to avoid any contact with the cleaned surface and thus eliminate any potential damage. Together, the improvements of the invention provide for the whole cleaning operation of solar panels to be made in a safer way and shorter time.

Furthermore, with introduction of solar panels on the roof of private residences or solar tiles as part of the house roof, those will need periodic cleaning to constantly keeping their efficiency high, where a drone system will be in handy. In the case of the solar tiles, to not impede their functionality, walking on these tiles might be prohibited, which dictates a maintenance where a drone system is the only option. Such drone system that has live-cameras will allow the assessment of the cleaning process efficiently and provide adaptability of the cleaning based on specific situation observed on the camera. The drones in preferable embodiments have collision sensors to avoid any contact with the solar panel, solar tiles or roof in general and thus eliminate any potential damage. Finally, the whole cleaning/dusting operation can be made in a safer way and shorter time and preferably is financial appealing for the owner of the house.

The same stands for mirrors used to reflect the solar rays towards a central water tower that heats up and produce steam, which is used via turbines to produce electricity. Such systems are known as the solar water heating systems. In this case drone system can be used to continuously or periodically inspect and clean the mirror panels, to maintain their full capacity to reflect the solar rays towards a central water tower. The drone operator stays all the time on the ground and coordinates the cleaning from the distance, avoiding unnecessary hazards. With a drone system, there are no limitations on how intricate and extended the mirror panels disposition and construction is in the solar power plant and because the drones have live-camera the cleaning process is efficient and adaptable based on specific situation observed on the camera. Thus, based on the grade/quantity of unwanted material deposit and soiling/fouling shown on live-camera on the mirror panels, the thrust of air and substances provided by the drone can be adjusted to accomplish a proper and gentle cleaning. In preferable embodiments, drones have collision sensors to avoid any contact with the cleaned surface and thus eliminate any potential damage. Together, the improvements of the invention provide for the whole inspection and cleaning operation of mirrors from the solar power tower plants to be made in a safer way and shorter time.

The embodiments disclosed in this patent preferably work with existing commercial drones that have 4 arms/4 propellers, such as the Airlift drone manufactured by Vulcan UAV LTD, UK, or Matrice and Phantom family drones manufactured by DJI, China. Other drones that can preferably be used include the Typhoon family manufactured by Yuneec, China, or X6 family manufactured by Tarot, China, or Alta 6 family manufactured by Freefly Systems, USA, which have 6 arms/6 propellers. Similarly, the T-18 drone family manufactured by Tarot, China or Alta 8 family manufactured by Freefly Systems, USA, can preferably be used that have 8 arms/8 propellers. It will be appreciated that there are more manufacturers of drones and different other models that are not mentioned above and that the foregoing is a non-exhaustive list of drone examples that can work for various embodiments presented in this patent application.

Embodiments of the invention will be described with reference to the accompanying figures, wherein like numbers represent like elements throughout. Further, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items. The terms “connected”, and “coupled” are used broadly and encompass both direct and indirect mounting, connecting and coupling. Further, “connected” and “coupled” are not restricted to physical or mechanical connections or couplings.

It is an objective of the present inventions to disclose different embodiments of inspection and cleaning systems using drones adapted for the inspection and/or removal of different materials and fouling organisms from gutters, historic buildings, monuments, silos, tall buildings exterior, different industrial or commercial or community tall structures (utility power plant chimneys, paper mill stacks, industrial chimney cleaning, marine smokestacks, rigging and lifting, bridges, dams, lighthouses, radio towers, landmark signage, large wind power turbines and church steeples), solar panels, solar roof tiles, mirrors for solar ray water heating systems, and the like.

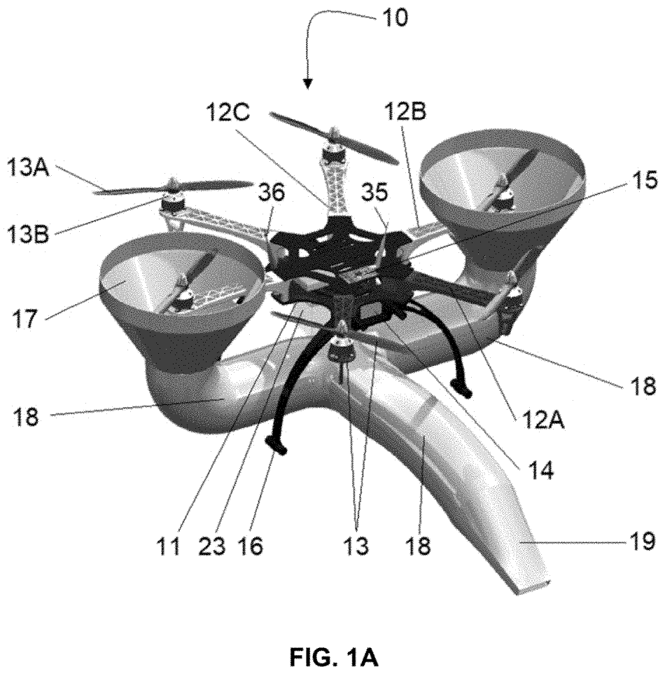

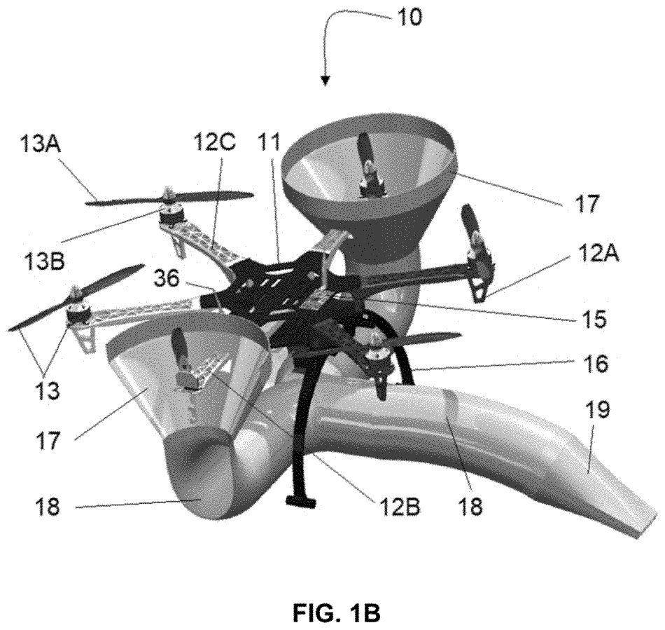

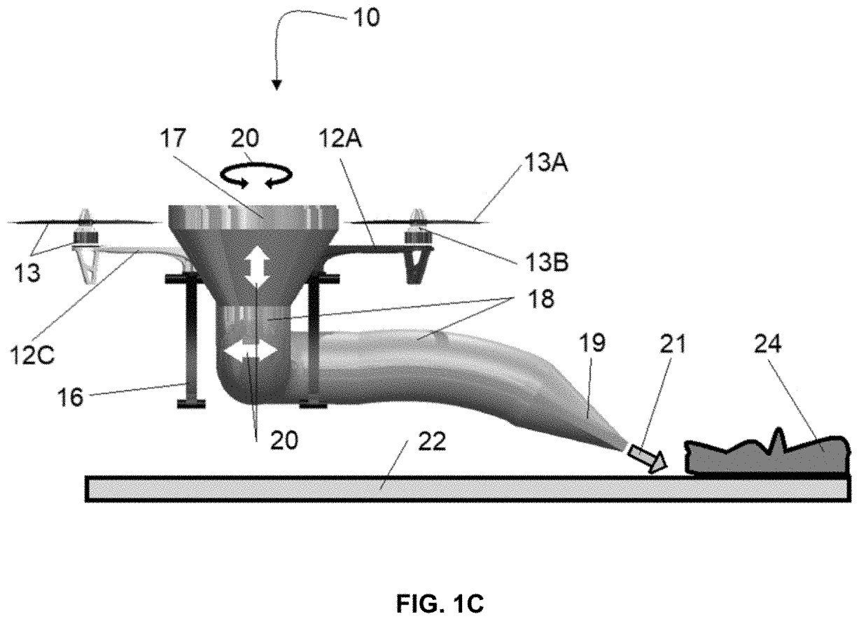

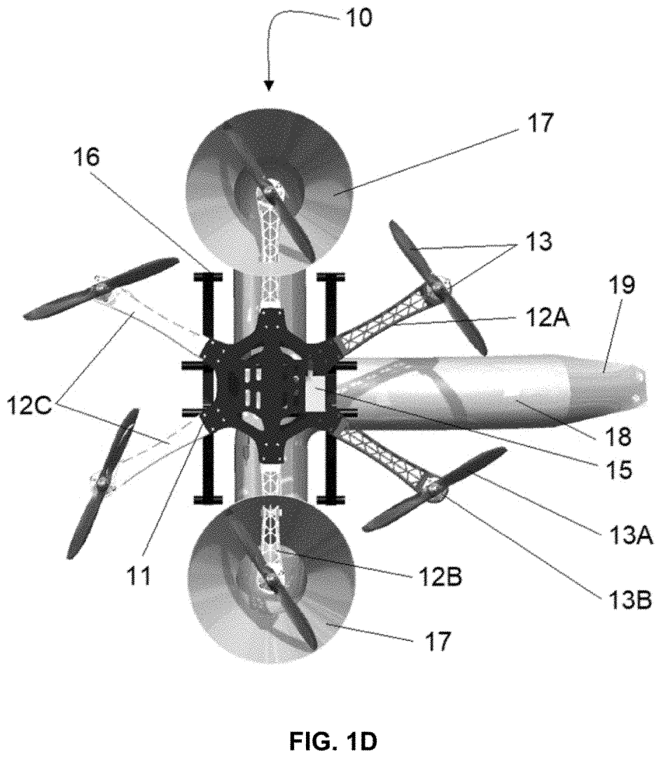

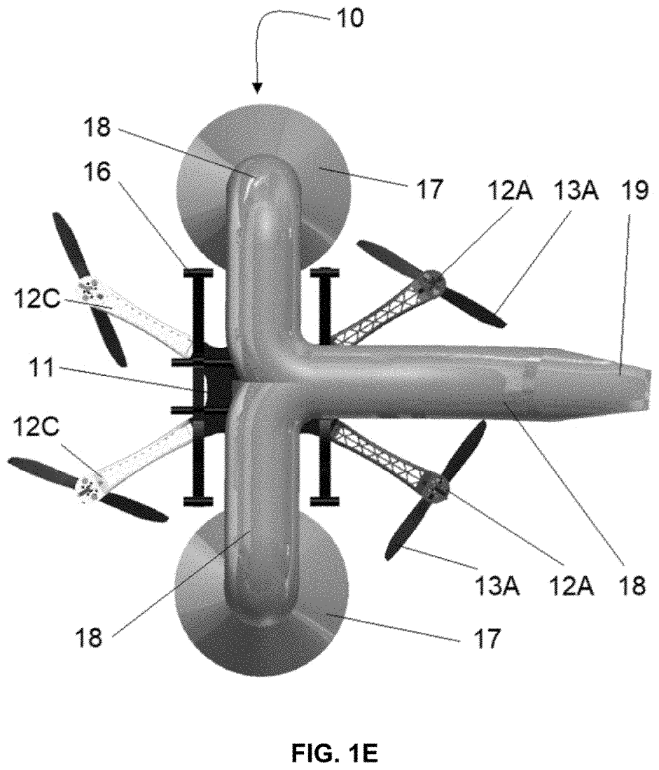

FIGS. 1A, 1B, 1C, 1D, and 1E depict an embodiment of the invention of a drone cleaning system 10 with total propeller thrust collection that includes the drone 11 adapted to collect thrust from multiple drone propeller assemblies 13, which includes an actual propeller 13A and the associated propeller motor 13B. The collection of the thrust from spinning propeller 13A is done via full air thrust collection funnel 17 including a propeller assembly 13 therein, preferably with multiple collection funnels 17 each including at least one propeller assembly, and then the thrust air flow is conducted via ducts of the duct system 18 (see FIG. 1B) towards the nozzle 19 into which the duct terminates. The collected air flow from the duct system 18 enters the nozzle 19 and then is expelled as a jet of air producing a drone blowing force 21 that is used to perform the cleaning of unwanted material deposit and soiling/fouling organisms 24 from the targeted structure surface 22 (see FIG. 1C). The ducts forming the duct system 18 in this case have a “T” shape (see FIG. 1E) in order to collect thrust from two opposite propeller assemblies 13 in funnels 17 and then conduct the air stream towards a central duct of the duct system 18 that ends in nozzle 19. Based on the type of drone 11 that is used (having 4 arms, 6 arms, 8 arms, or more), the duct system 18 can have different shapes, but basically there are lateral ducts that bring collected air from the propeller assemblies 13 in the funnels 17 towards the central duct of the duct system 18 that ends/terminates in nozzle 19. Also, as presented in FIG. 1B, it is preferred that the duct system 18 to have a round cross-section. However, any other cross-section geometry can be used as rectangular, square, oval, etc., based on the needs and design of a certain particular embodiment for a specific application.

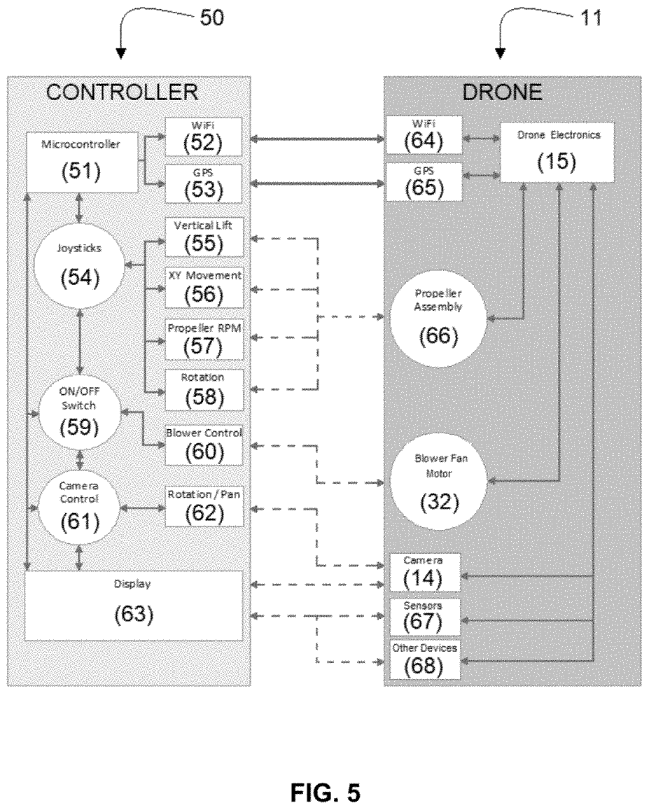

In this embodiment presented in FIGS. 1A, 1B, 1C, 1D, and 1E, two of the drone propeller assemblies 13 are used to collect thrust via thrust collection funnel 17 and the remaining four propeller assemblies 13 are used to produce the actual thrust necessary to move the drone 11 in a three-dimensional pattern. However, one, two or more than two drone propeller assemblies 13 can be used to collect thrust, depending on type of drone 11, which can have 4 arms, 6 arms, 8 arms, or more. In FIGS. 1A, 1B, 1C, 1D, and 1E illustrates a drone 11 that has two drone front arms 12A, two drone side arms 12B and two drone back arms 12C, with a total of 6 arms. Regardless of number of arms (4, 6, 8, or more), the drone 11 will use one or two or more propeller assemblies 13 to collect thrust for cleaning the targeted structure surface 22. In the embodiment from FIGS. 1A, 16, 1C, 1D, and 1E, the drone 11 uses two propeller assemblies 13 from two opposite arms to collect thrust for cleaning the targeted structure surface 22. The remaining propeller assemblies 13 will be used 100% by the drone 11 in a three-dimensional pattern for flying and maneuvering. The drone 11 has a landing gear 16 to allow the firm landing on the ground or dedicated ground surface. Also, the functionality of the drone cleaning system 10 with total propeller thrust collection is dictated by the on-board drone electronics 15, the WiFi antenna 35 and GPS antenna 36 that assure the connectivity with the cleaning system controller 50 (see FIG. 5), which the operator is using on the ground to control the drone cleaning system with total propeller thrust collection 10.

The state of the targeted structure surface 22 during inspection, or in cleaning phase, and after the cleaning can be continuously monitored by the operator of the drone cleaning system 10 with total propeller thrust collection, using camera 14 that directly communicates with cleaning system controller 50, which has a camera control module 61 and an associated rotation/pan submodule 62 (see FIG. 5) to move/pivot camera 14 in different directions. Camera 14 is used for the actual live visual assessment during inspection or cleaning and it is capable to transmit the live visual images via WiFi antenna 35 of the drone 11 to the camera control module 61 of the cleaning system controller 50 that has a display module 63 capable to show live images for the operator, who controls the drone cleaning system 10 with total propeller thrust collection.

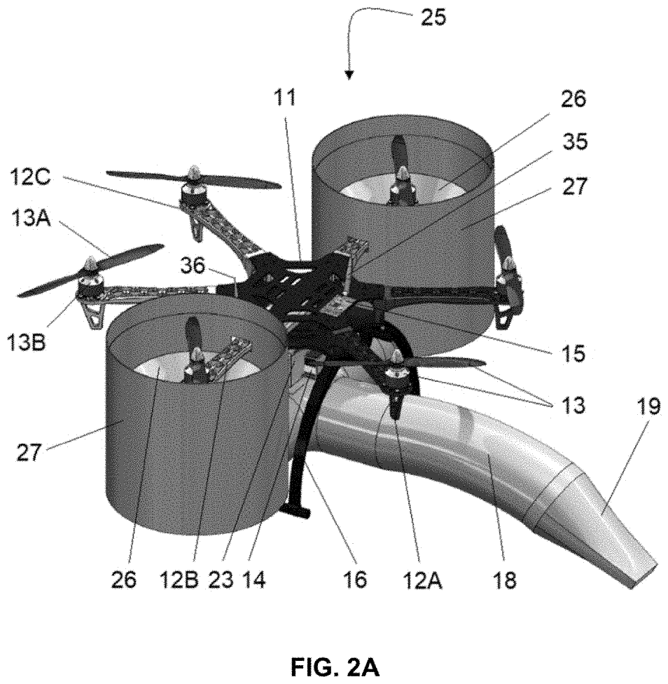

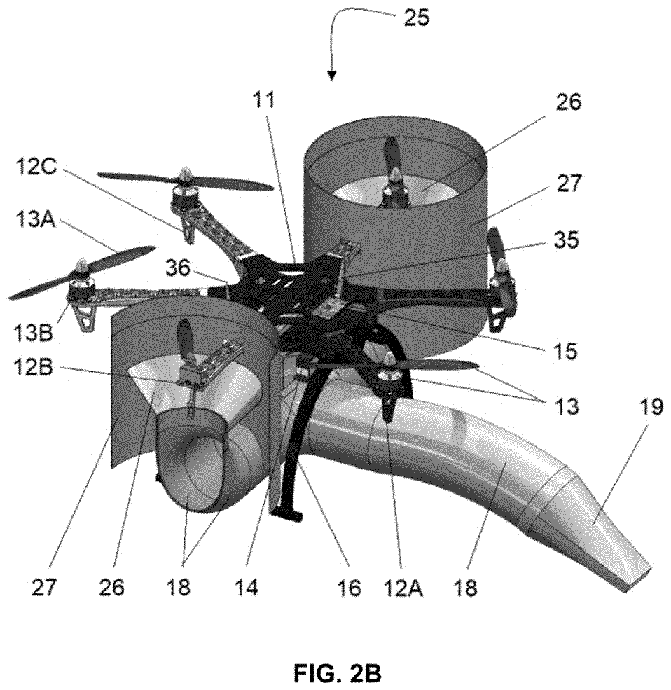

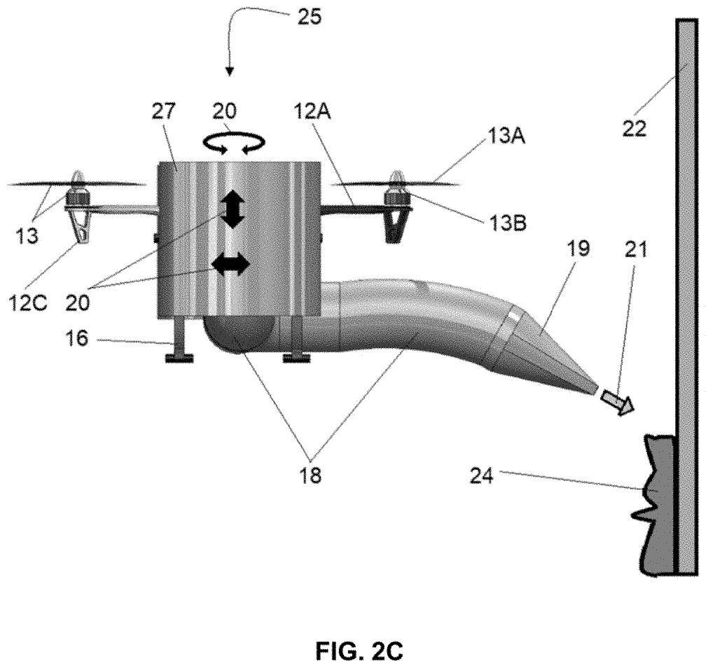

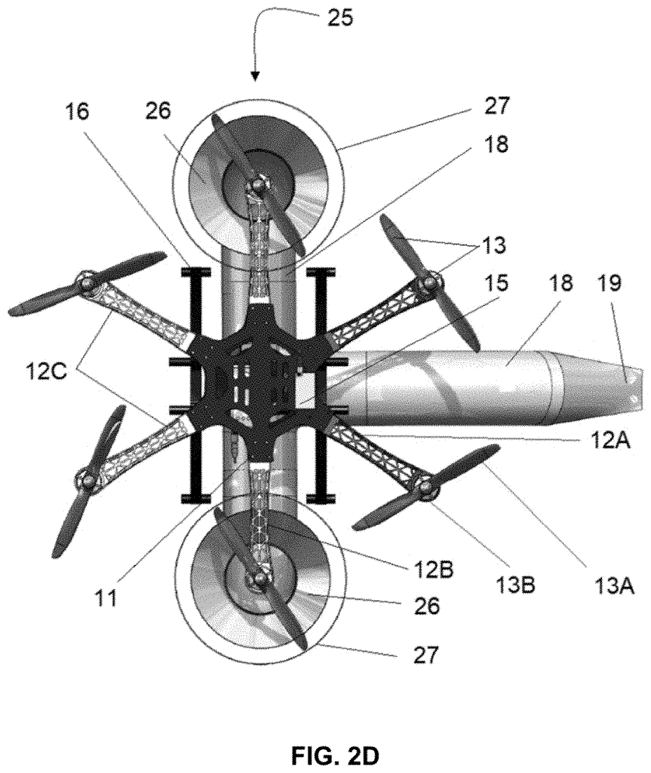

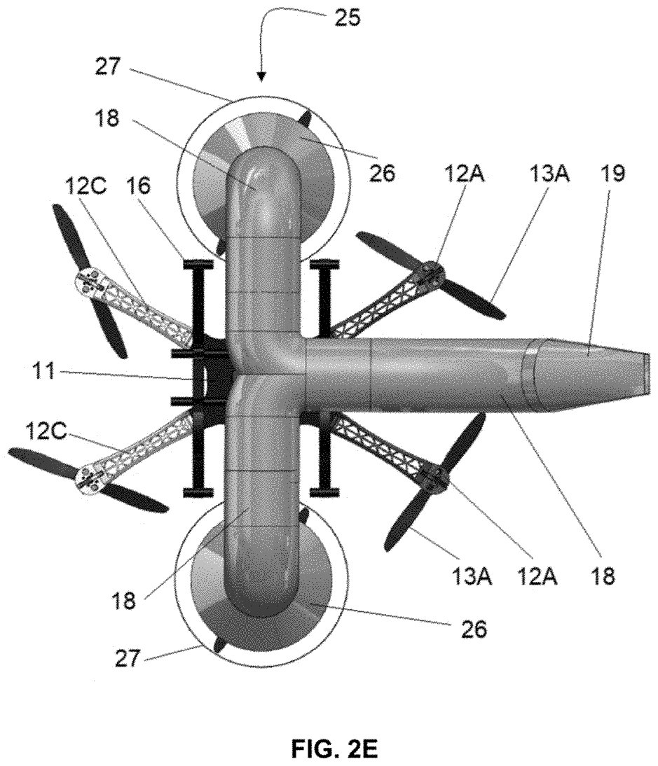

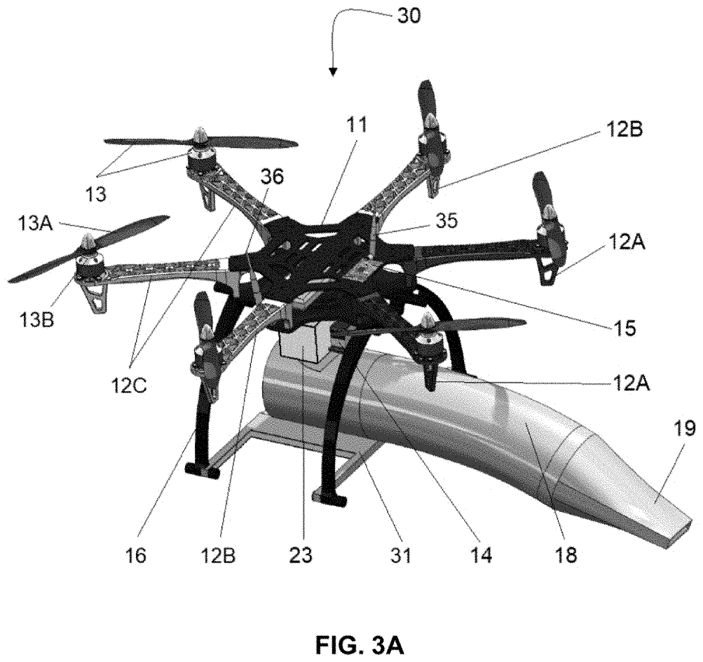

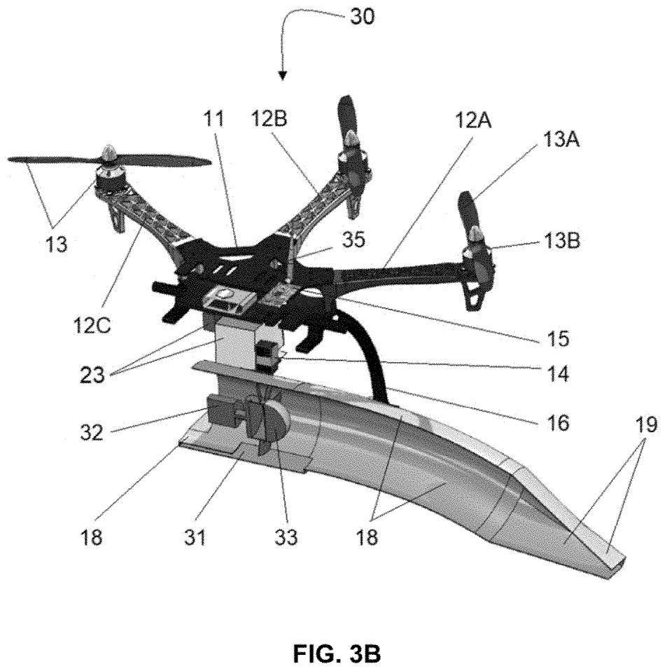

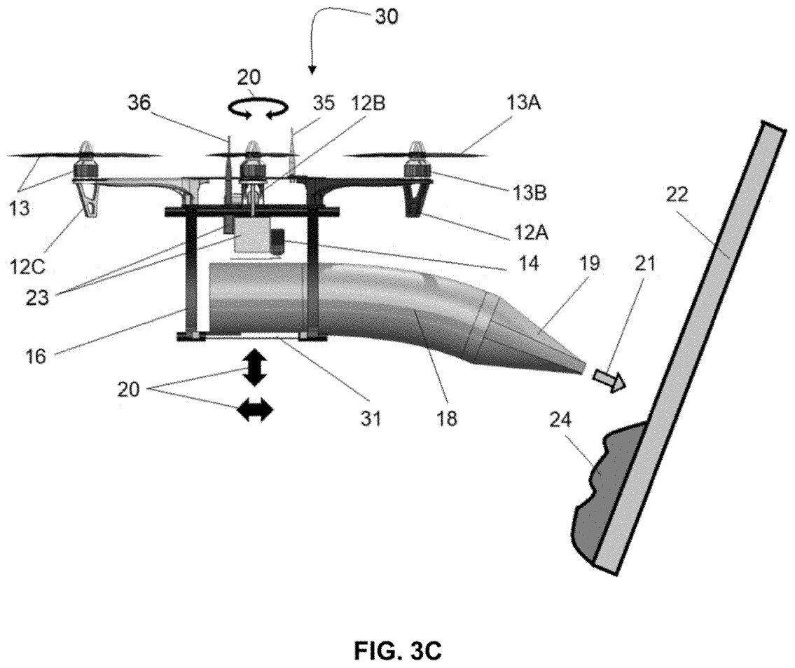

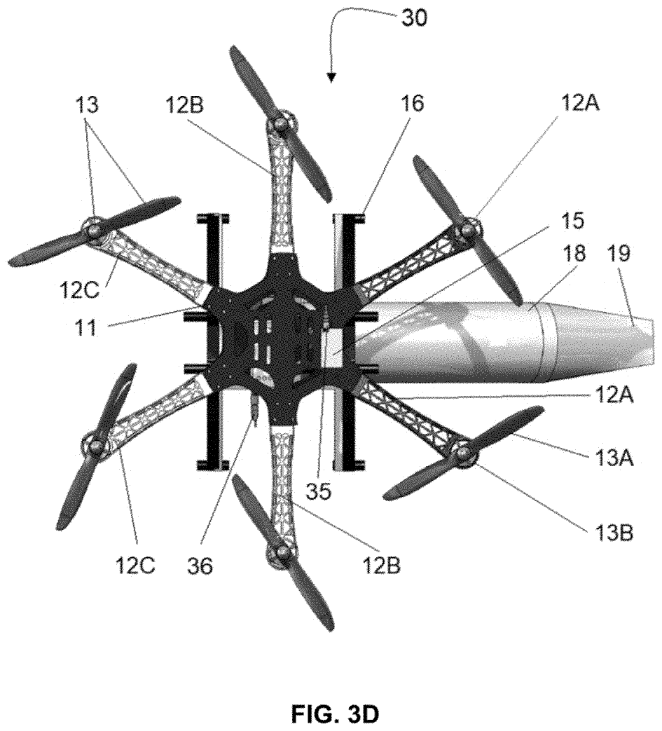

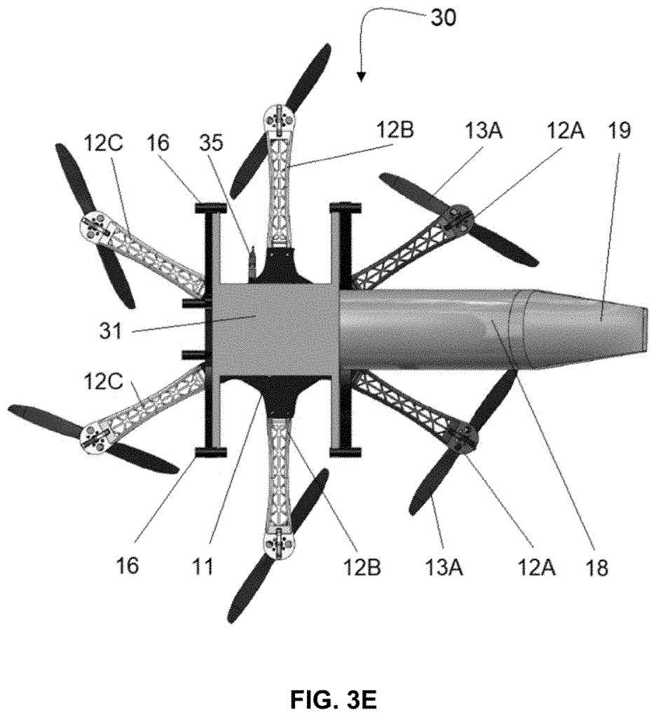

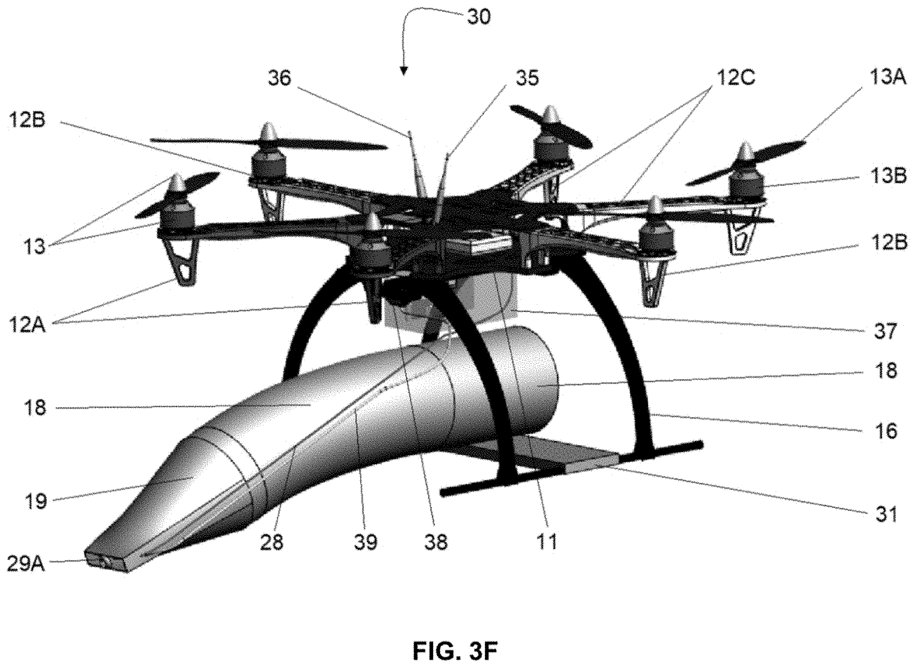

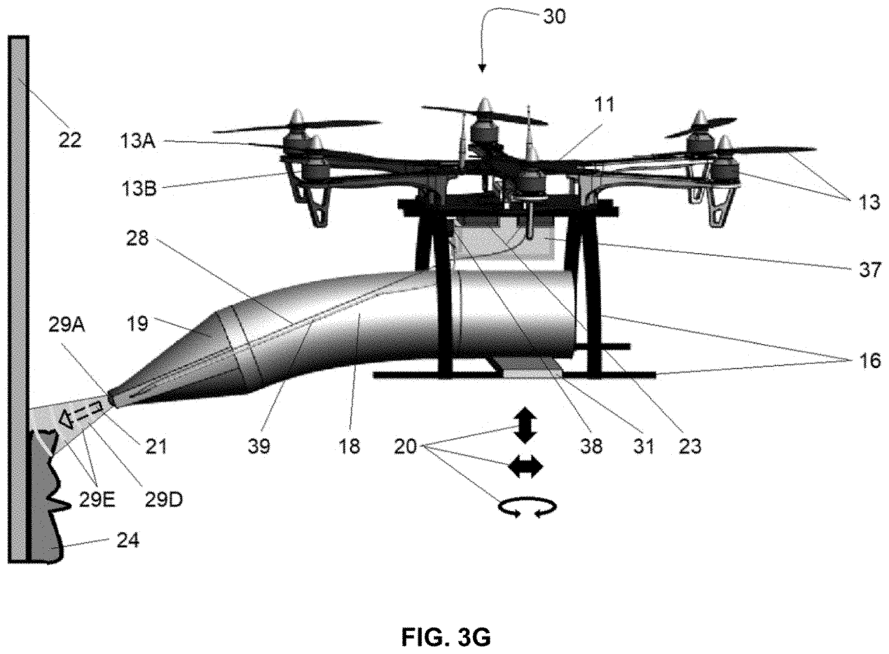

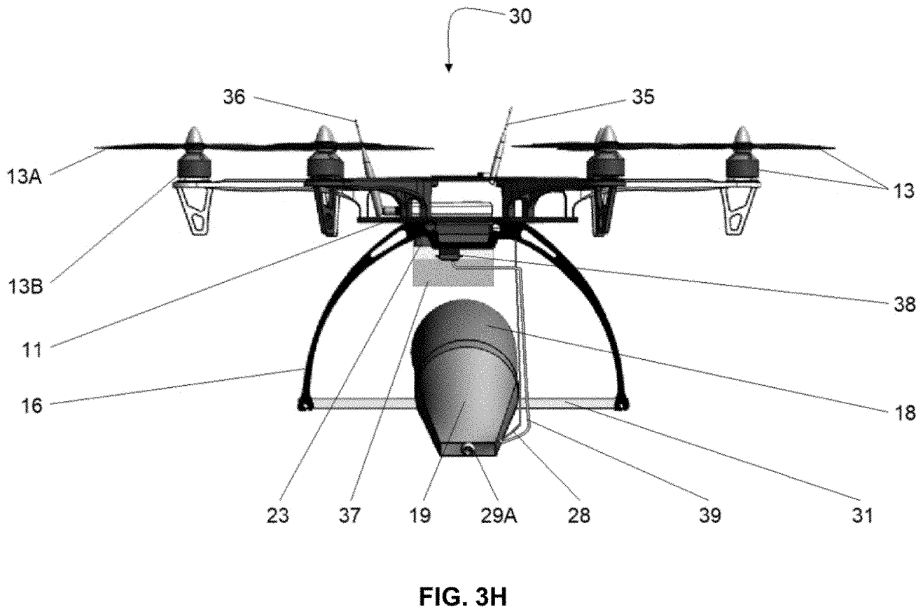

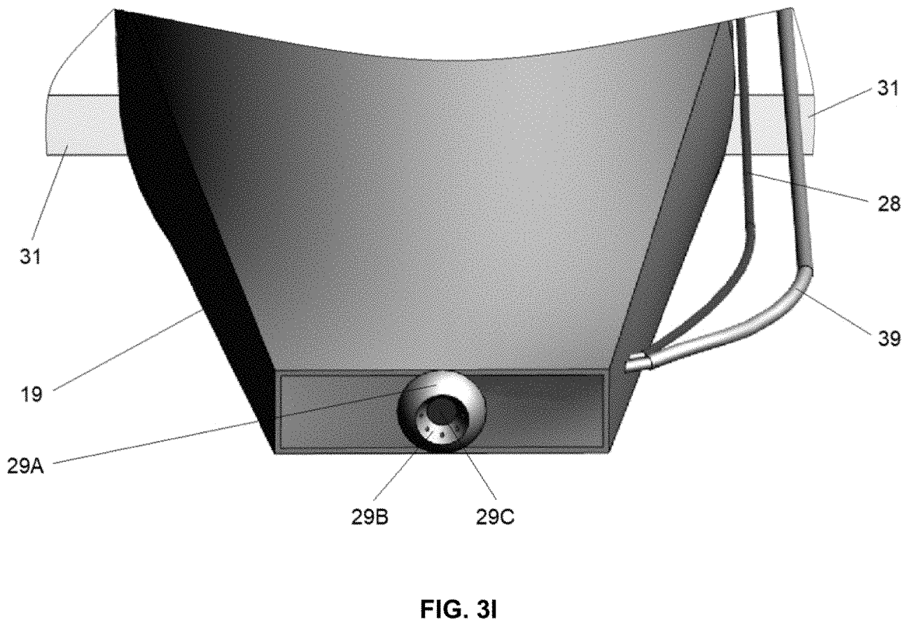

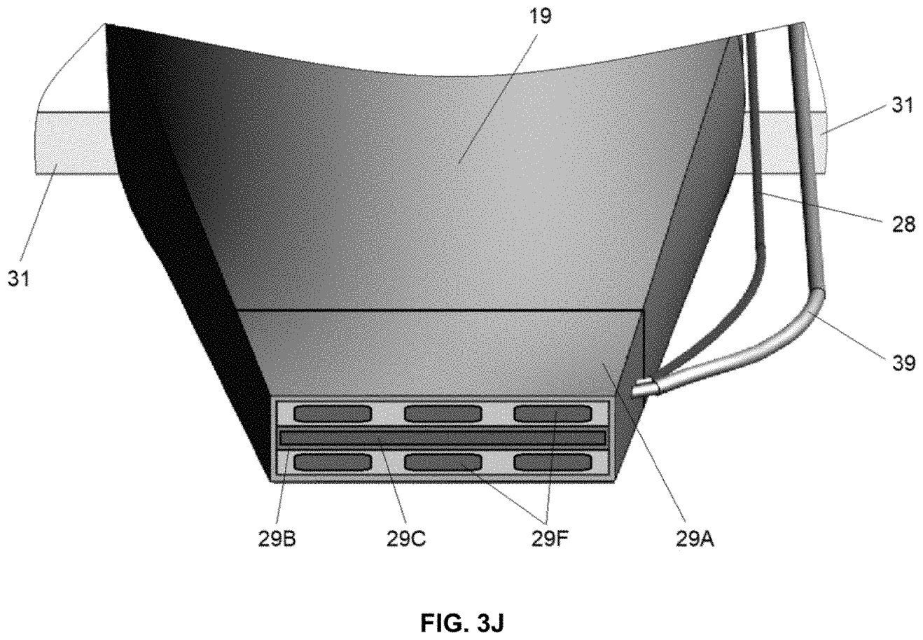

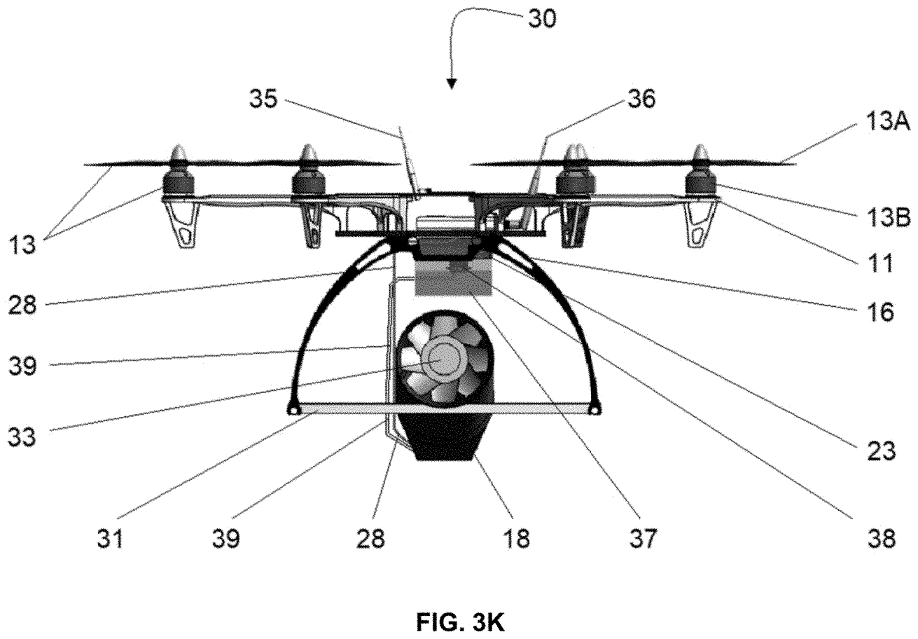

To correctly orient itself relatively to the targeted structure surface 22, the drone 11 needs to move in drone movement directions 20, which can be up and down direction, longitudinal direction (forward, backwards), and rotational direction (see FIG. 1C). Using the same drone movement directions 20 (vertical, horizontal, and rotational), the drone cleaning system 10 with total propeller thrust collection will be able to follow a certain pathway along or across the targeted structure surface 22 and thus cover the entire area of the targeted structure surface 22 that needs cleaning. Drone 11 preferably has collision sensors (not shown in this patent figures) in order to pursue the drone movement directions 20 without any possible collisions with the targeted structure surface 22. This is done via the cleaning system controller 50 that constantly communicates with the drone 11 and its respective sensors module 67, via one or more WiFi antennas 35 of the drone 11 (see FIG. 1A where only one WiFi antenna 35 is shown). Also, the instantaneous position of the drone 11 is all the time indicated and communicated in between the cleaning system controller 50 and the drone 11 via the GPS antenna 36, which allows the human operator to make any decisions to correct the drone 11 position, if necessary. Interesting to note is that although the targeted structure surface 22 is shown in FIG. 1C as horizontal, its orientation can be vertical (see FIG. 2C) or angled (see FIG. 3C), depending on the specificity of the structure that is cleaned.

The drone cleaning system 10 with total propeller thrust collection preferably is prepared on the ground for the operation/process that is desired to be performed (inspection and/or cleaning). The drone 11 should preferably have its battery block 23 charged in order to perform the operation. A battery block 23 usually contains one or two or four or more batteries mounted in parallel. For a normal commercial drone 11, the battery block 23 can last in between 15 minutes to maximum 50 minutes of flight time, depending on the weight load present on the drone 11, which produces some limitations in accomplishing the cleaning of more complex and large structures. The limitation of flight time can also be given by the weight of the attached elements to the drone 11, as the full air thrust collection funnel 17, duct system 18, and nozzle 19 that are part of the embodiment presented in FIGS. 1A, 1B, 1C, 1D, and 1E. In such cases, more than one battery block 23 could be used to complete the whole operation that might require a longer time beyond the time limit of a fully charged battery. However, it is preferred to use only one battery block 23 for one full operation, to avoid bringing the drone 11 back on the ground to change the battery block 23 with a new one, which is fully charged. A normal battery block 23 weight is between 300 g to 800 g, and when multiple battery blocks 23 are used it could add too much weight that can strain the drone 11 flight efficiency and capabilities, including the flight time. For the purpose of not getting the drone too heavy, preferably it is avoided to add an extra battery block 23 to the existing one from the drone 11. However, in some cases if the drone 11 is powerful or big enough to create a significant thrust or is specially designed to carry heavy weights, then multiple battery blocks 23 can be used to give more flight time and therefore allowing the inspection and/or cleaning in totality, without the need to land the drone 11 to change the battery blocks 23. Still, it is desired to limit the weight given by the battery blocks 23 to less than 3.5 kilograms.

In another embodiment, the drone 11 can use the propeller motors 13B to connect to a small dynamo that is a machine for converting mechanical energy into electrical energy or to a small electric generator (not shown in FIGS. 1A, 1B, 1C, 1D, and 1E). In this alternative embodiment, the propeller motors 13B must have shafts exiting on both ends, with the upper shaft being connected to the actual propeller 13A and the opposite lower shaft to be connected to the dynamo/generator. In this way the dynamos/generators can re-charge the batteries of the battery block 23 during the flight or operation time of the drone 11, by transforming the rotational movement produced by propeller motors 13B into electricity. In this manner, the life of the battery block 23 of the drone 11 can be extended with beneficial effects on continuity and efficiency of the inspection or cleaning operations.

In another embodiment, the life of the battery block 23 can be extended if the drone 11 has a mini-solar panel attached on its top (not shown in FIGS. 1A, 1B, 1C, 1D, and 1E), which can collect energy from the sun during the inspection and/or cleaning process and thus allows a longer flight time for the drone 11. In other situations, the thrust from the propeller assembly 13 can create air movement that can be captured by a mini-turbine attached to the drone 11 (not shown in FIGS. 1A, 1B, 1C, 1D, and 1E) that can generate energy and thus additionally charges the battery block 23 during flight, which will allow a longer flight time for the drone 11.

The drone cleaning system 10 with total propeller thrust collection presented in FIGS. 1A, 1B, 1C, 1D, and 1E, uses the full air thrust collection funnel 17, duct system 18, and nozzle 19 to create the air conduit and the overall additions to the drone 11 that allows the actual cleaning using jets of air coming out of the nozzle 19. The weight of the cumulated elements 17, 18, and 19 it is an important factor that can limit the performance of the drone cleaning system 10 with total propeller thrust collection. Higher weight will temper with the drone 11 capability to lift up, to fly, and with the flight time, since larger weights reduces the actual life of the battery blocks 23 used to power the drones 11. This is why it is important that the total weight of the cumulated elements 17, 18, and 19 preferably is in between 2 to 6 kilograms for allowing an optimum operation of the drone 11.

The materials used for the full air thrust collection funnel 17, duct system 18 and nozzle 19, are preferably light to make it easy for the drone to fly and to not consume unreasonably the power of the battery block 23 due to excessive weight. Preferably, the material is a light plastic or a rigidized and rubberized light cloth material or a strong water proof and rigidized light paper material. When made of plastic, the actual full air thrust collection funnel 17, duct system 18 and nozzle 19 can be manufactured via an injection molding process or 3D-printed. The full air thrust collection funnel 17, duct system 18 and nozzle 19 can be independent parts that are assembled together or can be produced, molded, or 3D printed as one integral assembly.

The operator is using the cleaning system controller 50 (see FIG. 5) to control from the ground the whole activity of the drone 11 and of the whole drone cleaning system 10 with total propeller thrust collection. The reception of commands from the cleaning system controller 50 to the drone 11 is done via the WiFi antenna 35. The drone 11 can be moved in the drone movement directions 20 (vertical, longitudinal or rotational) to be able to be positioned correctly relatively to the targeted structure surface 22 that needs inspection and/or cleaning. The instantaneous position of the drone 11 is all the time indicated and communicated in between the cleaning system controller 50 and the drone 11 via the GPS antenna 36.

Also, the drone cleaning system 10 with total propeller thrust collection presented in FIGS. 1A, 1B, 1C, 1D, and 1E, if the drone system can lift larger weights, then besides blowing air the drone can be capable of injecting fluid in the air stream or use other energy devices that can enhance the cleaning effect. The fluid can be water by itself or mixed with biocides, active detergents, cleaning substances, or special chemicals, which are environmentally friendly and are dissolved in the respective fluid, creating different mixtures that are used for removing stains, mildew, molds, fungi, algae, biofilms, etc. To enhance cleaning with the drone cleaning system 10 with total propeller thrust collection, energy devices can be attached to the duct system 18. Some of the energy devices preferable used are ultrasound piezo crystals that produce sound waves or shock waves transmitted through the liquid mist expelled from nozzle 19, or photodevices as lasers, or infrared-light LEDs (light emitting diodes)/OLEDs (organic light emitting diodes), or ultraviolet light lamps, etc. These embodiments are not specifically shown in FIGS. 1A, 1B, 1C, 1D, and 1E, but they are exemplified in FIGS. 3F-3K.

The nozzle 19 is designed to collect the air coming from the duct system 18 at a certain velocity. By changing its geometry from round cross-section to a smaller rectangular output cross-section, the nozzle 19 is able to speed up the air and thus creating a more powerful drone blowing force 21, which is increasing the cleaning efficiency of the targeted structure surface 22. If the duct system 18 has a cross-section different from round, then the nozzle 19 geometry is built in such way to significantly reduce the cross-section dimension from the dimensions of the duct system 18 to much lower dimensions of the nozzle 19 opening, to increase the velocity of the air at its exit from nozzle 19. In embodiments, where fluids are added to the air stream, the same principle applies to increase velocity of the air/fluid mixture. A much lower opening at the exit from nozzle 19 besides increasing air or air/fluid velocity it also helps with concentrated the jet of air or air/fluid mixture and drone blowing force 21 on a smaller area of the targeted structure surface 22 and thus increasing its cleaning efficiency of the material deposit and fouling organisms 24 (see FIG. 1C).

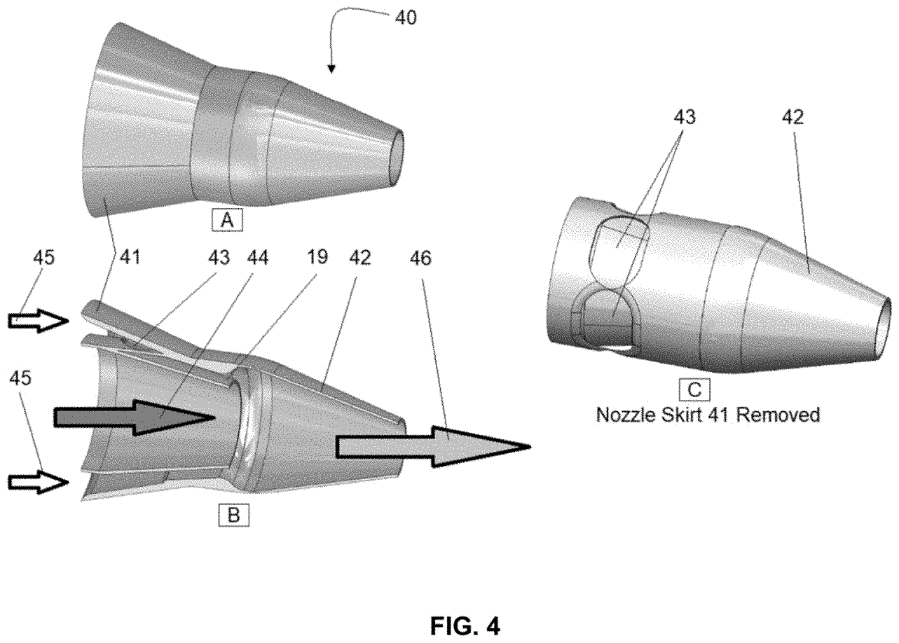

Furthermore, FIG. 4 illustrates an “extra air” intake nozzle 40 that allows the draw of extra air from outside the duct system 18 in the vicinity of the nozzle 19, in order to have an improved exit flow 46. Basically, the extra air intake nozzle 40 incorporates a normal nozzle 19 that is surrounded by a nozzle skirt 41 and has a secondary nozzle 42 that extends beyond nozzle 19. This design/embodiment allows the draw via the main flow 44 drag force of extra intake flow 45 from the air surrounding the extra air intake nozzle 40 and then guide it through intake opening 43 inside the secondary nozzle 42. By doing that, the main flow 44 is combined with the extra intake flow 45 resulting in an improved exit flow 46. Having more air drawn inside the extra air intake nozzle 40 combined with dimensional reduction at the exit from the secondary nozzle 42 will ultimately results in an increased drone blowing force 21 and amplified cleaning efficiency of the unwanted material deposit and soiling/fouling organisms 24 (see FIG. 1C).

The embodiments of the drone cleaning system 10 with total propeller thrust collection presented in FIGS. 1A, 1B, 1C, 1D, and 1E can be used to clean gutters, historic buildings, monuments, silos, tall buildings and high rises, bridges, dams, solar panels, solar roof tiles, mirrors for solar ray water heating systems, large satellite dishes or telescopes, gondola lifts, billboards and large signs, different industrial or commercial or community tall structures (utility power plant chimneys, paper mill stacks, industrial chimney cleaning, marine smokestacks, rigging and lifting, bridges, dams, lighthouses, radio towers, landmark signage, large power wind turbines, and church steeples), large aircrafts and ships, space crafts or rockets and launching pads, busses and large trucks, large earth-moving equipment, elevator shafts, large pipes and ducts, mine shafts, large storage containers (water, oil, chemicals, etc.), shipping containers, stadiums or sport venues on the inside and outside, special large roofs, the inside of buildings or theaters or museums that have large atriums, and other similar structures to name a few. Similarly, the drone cleaning system 10 with total propeller thrust collection presented in FIGS. 1A, 1B, 1C, 1D, and 1E can be used to blow objects (in air, on land or on water), debris (in air, on land or on water), substances (in air, on land or on water), or materials floating on water (e.g., lakes, rivers, ocean and like bodies).

FIGS. 2A, 2B, 2C, 2D, and 2E depict an embodiment of a drone cleaning system 25 with partial propeller thrust collection assemblage that includes the drone 11 adapted to collect partially the thrust from multiple drone propeller assemblies 13, which includes an actual propeller 13A and the associated propeller motor 13B. The partially collection of the thrust from propeller 13A is done via the partial air thrust collection funnel 26 and then the thrust air is conducted via ducts/duct system 18 (see FIG. 2B) towards the nozzle 19 where is expelled as jet of air producing a drone blowing force 21 that is used to perform the cleaning of unwanted material deposit and soiling/fouling organisms 24 from the targeted structure surface 22 (see FIG. 2C). The general collection of the thrust from the drone propeller assemblies 13 is done via the external cylindrical thrust collector 27 that allows some of the trust to go on the outside of the partial air thrust collection funnel 26 and thus contributing to the drone 11 lifting (see FIGS. 2B, 2D, and 2E). In some cases, this partial collection of the thrust is necessary to not significantly impede with the normal functioning of the drone 11, as lifting or flying, while some of the thrust is collected via the partial air thrust collection funnel 26 for the cleaning activity of the drone cleaning system 25 with partial propeller thrust collection assemblage. The ducts forming the duct system 18 in this case have a “T” shape (see FIG. 2E) in order to collect thrust from two opposite propeller assemblies 13 and then conduct the air stream towards a central duct of the duct system 18 that ends in nozzle 19. Based on the type of drone 11 that is used (having 4 arms, 6 arms, 8 arms, or more) the duct system 18 can have different shapes, but basically there are lateral ducts that bring collected air from the propeller assemblies 13 towards the central duct of the duct system 18 that ends in nozzle 19. Also, as presented in FIG. 2B, it is preferred that the duct system 18 to have a round cross-section. However, any other cross-section geometry can be used as rectangular, square, oval, etc., based on the needs and design of a certain particular embodiment for a specific application.

In this embodiment presented in FIGS. 2A, 2B, 2C, 2D, and 2E, two of the drone propeller assemblies 13 are used to direct the thrust using the external cylindrical thrust collector 27 and to collect a portion of the thrust via partial air thrust collection funnel 26 to direct air flow via duct system 18 and nozzle 19 towards the targeted structure surface 22. The remaining four propeller assemblies 13 are used to produce the additional thrust necessary to move the drone 11 in a three-dimensional pattern for flying and maneuvering. However, one, two or more than two drone propeller assemblies 13 can be used to collect thrust, depending on type of drone. Some of the drones 11 can have 4 arms, 6 arms, 8 arms, or more, which can change the number of propeller assemblies 13 that are used to collect thrust for cleaning the targeted structure surface 22. FIGS. 2A, 2B, 2C, 2D, and 2E illustrate a drone 11 that has two drone front arms 12A, two drone side arms 12B and two drone back arms 12C, with a total of 6 arms. The drone 11 has a landing gear 16 to allow the firm landing on the ground or dedicated ground surface. Also, the functionality of the drone cleaning system 25 with partial propeller thrust collection assemblage is dictated by on-board drone electronics 15 that communicates via a WiFi antenna 35 and a GPS antenna 36 with the cleaning system controller 50 (see FIG. 5), which the operator is using on the ground to control the drone cleaning system 25 with partial propeller thrust collection assemblage.

The state of the targeted structure surface 22 during inspection, or in cleaning phase, and after the cleaning can be continuously monitored by the operator of the drone cleaning system 25 with partial propeller thrust collection assemblage, using camera 14 that directly communicates with cleaning system controller 50, which has a camera control module 61 and an associated rotation/pan submodule 62 (see FIG. 5) to move/pivot camera 14 in different directions. Camera 14 is used for the actual live visual assessment during inspection or cleaning and it is capable to transmit the live visual images via WiFi antenna 35 of the drone 11 to the camera control module 61 of the cleaning system controller 50 that has a display 63 to show live images to the operator, who controls the drone cleaning system 25 with partial propeller thrust collection assemblage.

To correctly orient itself relatively to the targeted structure surface 22, the drone 11 needs to move in drone movement directions 20, which can be up and down direction, longitudinal direction (forward, backwards), and rotational direction (see FIG. 2C). Using the same drone movement directions 20 (vertical, horizontal, and rotational), the drone cleaning system 25 with partial propeller thrust collection assemblage will be able to follow a certain pathway along or across the targeted structure surface 22 and thus cover the entire area of the targeted structure surface 22 that needs cleaning. Drone 11 preferably has collision sensors (not shown in this patent figures) in order to pursue the drone movement directions 20 without any possible collisions with the targeted structure surface 22. This is done via the cleaning system controller 50 that constantly communicates with the drone 11 and its respective sensors module 67, via one or more WiFi antennas 35 of the drone 11 (see FIG. 2A where only one WiFi antenna 35 is shown). Also, the instantaneous position of the drone 11 is all the time indicated and communicated in between the cleaning system controller 50 and the drone 11 via the GPS antenna 36, which allows the human operator to make any decisions to correct the drone 11 position, if necessary. Interesting to note is that although the targeted structure surface 22 is shown in FIG. 2C as vertical, its orientation can be horizontal (see FIG. 1C) or angled (see FIG. 3C), depending on the specificity of the structure that is cleaned.

The drone cleaning system 25 with partial propeller thrust collection assemblage preferably is prepared on the ground for the operation/process that is desired to be performed (inspection and/or cleaning). The drone 11 should preferably have its battery block 23 charged in order to perform the operation. As mentioned before, a battery block 23 usually contains one or two or four or more batteries mounted in parallel. For a normal commercial drone 11, the battery block 23 can last in between 15 minutes to maximum 50 minutes of flight time, depending on the weight load present on the drone 11, which produces some limitations in accomplishing the cleaning of more complex and large structures. The limitation of flight time can also be given by the weight of the attached elements to the drone 11, as the partial air thrust collection funnel 26, external cylindrical thrust collector 27 (that may have other shapes in other embodiments), duct system 18, and nozzle 19 that are part of the embodiment presented in FIGS. 2A, 2B, 2C, 2D, and 2E. In such cases, more than one battery block 23 could be used to complete the whole operation that might require a longer time beyond the time limit of a fully charged battery. However, it is preferred to use only one battery block 23 for one full operation, to avoid bringing the drone 11 back on the ground to change the battery block 23 with a new one, which is fully charged. A normal battery block 23 weights in between 300 g to 800 g, and when multiple battery blocks 23 are used may add excessively weight that can strain the drone 11 flight efficiency and capabilities, including the flight time. For the purpose of not getting the drone too heavy, preferably it is avoided to add an extra battery block 23 to the existing one from the drone 11. However, in some cases if the drone 11 is powerful or big enough to create a significant thrust or is specially designed to carry heavy weights, then multiple battery blocks 23 can be used to give more flight time and therefore allowing the inspection and/or cleaning in totality, without the need to land the drone 11 to change the battery block 23. Still, it is desired to limit the weight given by the battery blocks 23 to less than 3.5 kilograms.

In another embodiment, the drone 11 can use the propeller motors 13B to connect to a small dynamo, which is a machine for converting mechanical energy into electrical energy, or to a small electric generator (not shown in FIGS. 2A, 2B, 2C, 2D, and 2E). For this the propeller motors 13B must have shafts exiting on both ends, with the upper shaft being connected to the actual propeller 13A and the opposite lower shaft to be connected to the dynamo/generator. In this way the dynamos/generators can re-charge the batteries of the battery block 23 during the flight or operation time of the drone 11, by transforming the rotational movement produced by propeller motors 13B into electricity. Thus, the life of the battery block 23 of the drone 11 can be extended with beneficial effects on continuity and efficiency of the inspection or cleaning operations.

In another embodiment, the life of the battery block 23 can be extended if the drone 11 has a mini-solar panel attached on its top (not shown in FIGS. 2A, 2B, 2C, 2D, and 2E), which can collect energy from the sun during the inspection and/or cleaning process and thus allows a longer flight time for the drone 11. In other situation the thrust from the propeller assembly 13 can create air movement that can be captured by a mini-turbine attached to the drone 11 (not shown in FIGS. 2A, 2B, 2C, 2D, and 2E) that can generate energy and thus additionally charges the battery block 23 during flight, which will allow a longer flight time for the drone 11.

The drone cleaning system 25 with partial propeller thrust collection assemblage presented in FIGS. 2A, 2B, 2C, 2D, and 2E, uses the partial air thrust collection funnel 26, external cylindrical thrust collector 27, duct system 18, and nozzle 19 to create the air conduit and the overall additions to the drone 11 that allows the actual cleaning using jets of air coming out of the nozzle 19. The weight of the cumulated elements 26, 27, 18, and 19 it is an important factor that can limit the performance of the drone cleaning system 25 with partial propeller thrust collection assemblage. The higher weight will temper with the drone 11 capability to lift up, to fly, and with the flight time, since larger weights reduces the actual life of the battery blocks 23 used to power the drones 11. This is why it is important that the total weight of the cumulated elements 26, 27, 18, and 19 preferably is in between 2.5 to 6.5 kilograms for allowing an optimum operation of the drone 11.

The materials used for the partial air thrust collection funnel 26, external cylindrical thrust collector 27, duct system 18, and nozzle 19, are preferably light to make it easy for the drone to fly and to not consume unreasonably the power of the battery block 23, due to excessive weight. Preferably, the material is a light plastic or a rigidized and rubberized light cloth material or a strong water proof and rigidized light paper material. When made of plastic, the actual partial air thrust collection funnel 26, external cylindrical thrust collector 27, duct system 18, and nozzle 19 can be manufactured via an injection molding process or 3D-printed. The partial air thrust collection funnel 26, external cylindrical thrust collector 27, duct system 18, and nozzle 19 can be independent parts that are assembled together or can be produced, molded, or 3D printed as one integral assembly.

As mentioned before for the embodiment presented in FIGS. 1A, 1B, 1C, 1D, and 1E, for the embodiment presented in FIGS. 2A, 2B, 2C, 2D, and 2E the operator is using the cleaning system controller 50 (see FIG. 5) to control from the ground the whole activity of the drone 11 and of the whole drone cleaning system 25 with partial propeller thrust collection assemblage. The reception of commands from the cleaning system controller 50 to the drone 11 is done via the WiFi antenna 35 and for the current position of the drone in space via the GPS antenna 36. Thus, the drone 11 can be moved in the drone movement directions 20 (vertical, longitudinal or rotational) to be able to be positioned correctly relatively to the targeted structure surface 22 that needs inspection and/or cleaning.

Also, the whole drone cleaning system 25 with partial propeller thrust collection assemblage presented in FIGS. 2A, 2B, 2C, 2D, and 2E, if the drone system can lift larger weights, then besides blowing air the drone can be capable of injecting fluid in the air stream or use other energy devices that can enhance the cleaning effect. The fluid can be water by itself or mixed with biocides, active detergents, cleaning substances, or special chemicals, which are environmentally friendly and are dissolved in the respective fluid, creating different mixtures that are used for removing stains, molds, mildew, fungi, algae, biofilms, etc. To enhance cleaning with the whole drone cleaning system 25 with partial propeller thrust collection assemblage, energy devices can be attached to the duct system 18. Some of the energy devices preferable used are piezo crystals that produce ultrasound or sound waves or shock waves transmitted through the liquid mist expelled from nozzle 19, or photodevices as lasers, or infrared-light LEDs (light emitting diodes)/OLEDs (organic light emitting diodes), or ultraviolet light lamps, etc. These embodiments are not specifically shown in FIGS. 2A, 2B, 2C, 2D, and 2E, but they are exemplified in FIGS. 3F-3K.

As mentioned before for the embodiment presented in FIGS. 1A, 1B, 1C, 1D, and 1E, for the embodiment presented in FIGS. 2A, 2B, 2C, 2D, and 2E the nozzle 19 is also designed to collect the air coming from the duct system 18 at a certain velocity. By changing its geometry from round cross-section to a smaller rectangular output cross-section, the nozzle 19 is able to speed up the air and thus creating a more powerful drone blowing force 21, which is increasing the cleaning efficiency of the targeted structure surface 22. If the duct system 18 has a cross-section different from round, then the nozzle 19 geometry is built in such way to significantly reduce the cross-section dimension from the dimensions of the duct system 18 to much lower dimensions at the opening of the nozzle 19, in order to increase the velocity of the air at its exit from nozzle 19. In embodiments, where fluids are added to the air stream, the same principle applies to increase velocity of the air/fluid mixture. A much lower opening at the exit from nozzle 19 besides increasing air or air/fluid velocity it also helps with concentrated the jet of air or air/fluid mixture and drone blowing force 21 on a smaller area of the targeted structure surface 22 and thus increasing its cleaning efficiency of the material deposit and fouling organisms 24 (see FIG. 2C). Furthermore, the nozzle design presented in FIG. 4 also applies for the embodiment presented in FIGS. 2A, 2B, 2C, 2D, and 2E, which can be used to increase the drone blowing force 21 and finally the cleaning efficiency of the drone cleaning system 25 with partial propeller thrust collection assemblage.

The embodiments of the drone cleaning system 25 with partial propeller thrust collection assemblage presented in FIGS. 2A, 2B, 2C, 2D, and 2E can be used to clean gutters, historic buildings, monuments, silos, tall buildings and high rises, bridges, dams, solar panels, solar roof tiles, mirrors for solar ray water heating systems, large satellite dishes or telescopes, gondola lifts, billboards and large signs, different industrial or commercial or community tall structures (utility power plant chimneys, paper mill stacks, industrial chimney cleaning, marine smokestacks, rigging and lifting, bridges, dams, lighthouses, radio towers, landmark signage, large wind power turbines, and church steeples), large aircrafts and ships, space crafts or rockets and launching pads, busses and large trucks, large earth-moving equipment, elevator shafts, large pipes and ducts, mine shafts, large storage containers (water, oil, chemicals, etc.), shipping containers, stadiums or sport venues on the inside and outside, special large roofs, the inside of buildings or theaters or museums that have large atriums, and other similar structures to name a few. Similarly, the drone cleaning system 25 with partial propeller thrust collection assemblage presented in FIGS. 2A, 2B, 2C, 2D, and 2E can be used to blow objects (in air, on land or on water), debris (in air, on land or on water), substances (in air, on land or on water), or materials floating on water (e.g., lakes, rivers, ocean and like bodies).

In some cases, the construction/design and thrust power of the drone 11 does not allow the collection of any thrust from drone propeller assemblies 13 to direct the thrust air via the duct system 18 towards a nozzle 19, to produce air jets for cleaning of a specific structure. For this specific type of situation, FIGS. 3A, 3B, 3C, 3D, 3E, 3F, 3G, 3H, 3I, 3J and 3K depict an embodiment of a drone cleaning system 30 with dedicated air blower that includes a blower fan 33 (see FIGS. 3B and 3K) to produce the jets of air for cleaning the targeted structure surface 22. In this embodiment the drone 11 has the capability to sustain additional weight from the sustaining platform 31, blower fan 33, blower fan motor 32, duct 18, and nozzle 19. For the drone cleaning system 30 with dedicated air blower, the blower fan 33 produces high velocity air circulation inside the duct 18 towards the nozzle 19 where is expelled as jet of air producing a drone blowing force 21 that is used to perform the cleaning of material deposit and fouling organisms 24 from the targeted structure surface 22 (see FIGS. 3C and 3G). The advantage of this embodiment presented in FIGS. 3A-3K is that the drone 11 is using the full power of all available propeller assemblies 13 for lifting and three-dimensional navigation pattern for flying and maneuvering of the drone cleaning system 30 with dedicated air blower along the targeted structure surface 22. The duct 18 can have a round cross-section. However, any other cross-section geometry can be used as rectangular, square, oval, etc., based on the needs and design of a certain particular embodiment for a specific application.

The drone 11 used for the drone cleaning system 30 with dedicated air blower has a landing gear 16 to allow the firm landing on the ground or dedicated ground surface. The same landing gear 16 is used to attach/support the sustaining platform 31, which on its turn supports the blower fan 33, blower fan motor 32, and the duct 18. Also, the functionality of the drone cleaning system 30 with dedicated air blower is dictated by on-board drone electronics 15 that communicates via a WiFi antenna 35 and a GPS antenna 36 with the cleaning system controller 50 (see FIG. 5), which the operator is using on the ground to control the drone cleaning system 30 with dedicated air blower. The instantaneous position of the drone 11 is all the time indicated and communicated in between the cleaning system controller 50 and the drone 11 via the GPS antenna 36. This allows the human operator to make any decisions to correct the drone 11 position and adjust the drone movement directions 20 (vertical, longitudinal or rotational) to position the drone 11 correctly relatively to the targeted structure surface 22 that needs inspection and/or cleaning.

The state of the targeted structure surface 22 during inspection, in cleaning phase, and after the cleaning can be continuously monitored by the operator of the drone cleaning system 30 with dedicated air blower, using camera 14 that directly communicates with cleaning system controller 50, which has a camera control module 61 and an associated rotation/pan submodule 62 (see FIG. 5) to move/pivot camera 14 in different directions. Camera 14 is used for the actual live visual assessment during inspection or cleaning and it is capable to transmit the live visual images via WiFi antenna 35 of the drone 11 to the camera control module 61 of the cleaning system controller 50 that has a display 63 to show live images to the operator, who controls the drone cleaning system 30 with dedicated air blower.

To correctly orient itself relatively to the targeted structure surface 22, the drone 11 needs to move in movement directions 20, which can be up and down direction, longitudinal direction (forward, backwards), and rotational direction (see FIGS. 3C and 3G). Using the same movement directions 20 (vertical, horizontal, and rotational), the drone cleaning system 30 with dedicated air blower will be able to follow a certain pathway along or across the targeted structure surface 22 and thus cover the entire area of the targeted structure surface 22 that needs cleaning. Drone 11 preferably has collision sensors (not shown in this patent figures) in order to pursue the movement directions 20 without any possible collisions with the targeted structure surface 22. This is done via the cleaning system controller 50 that constantly communicates with the drone 11 and its respective sensors module 67, via one or more WiFi antennas 35 of the drone 11 (see FIG. 2A where only one WiFi antenna 35 is shown). Also, the instantaneous position of the drone 11 is all the time indicated and communicated in between the cleaning system controller 50 and the drone 11 via the GPS antenna 36, which allows the human operator to make any decisions to correct the drone 11 position, if necessary. Interesting to note is that although the targeted structure surface 22 is shown in FIG. 3C as angled and in FIG. 3G as vertical (see also FIG. 2C), its orientation can be also horizontal (see FIG. 1C) depending on the specificity of the structure that is cleaned.

The drone cleaning system 30 with dedicated air blower preferably is prepared on the ground for the operation/process that desired to be performed (inspection and/or cleaning). The drone 11 preferably has its battery block 23 charged in order to perform the operation. As mentioned before, a battery block 23 usually contains one or two or four or more batteries mounted in parallel. For a normal commercial drone 11, the battery block 23 can last in between 15 minutes to maximum 50 minutes of flight time, depending on the load present on the drone 11, which produce some limitations in accomplishing the cleaning of more complex and large structures. The limitation of flight time can also be given by the weight of the attached elements to the drone 11, as the sustaining platform 31, blower fan motor 32, blower fan 33, duct system 18, and nozzle 19 that are part of the embodiment presented in FIGS. 3A-3K. In such cases, more than one battery block 23 could be used to complete the whole operation that might require a longer time beyond the time limit of a fully charged battery. However, it is preferred to use only one battery block 23 for one full operation, to avoid bringing the drone 11 back on the ground to change the battery block 23 with a new one, which is fully charged. A normal battery block 23 weights in between 300 g to 800 g, and when multiple battery blocks 23 are used may add enough weight that can strain the drone 11 flight efficiency and capabilities, including the flight time. For the purpose of not getting the drone too heavy, preferably it is avoided to add an extra battery block 23 to the existing one from the drone 11. However, in some cases if the drone 11 is powerful or big enough to create a significant thrust or is specially designed to carry heavy weights, then multiple battery blocks 23 can be used to give more flight time and therefore allowing the inspection and/or cleaning in totality, without the need to land the drone 11 to change the battery block 23. Still, it is desired to limit the weight given by the battery blocks 23 to less than 3.5 kilograms.

In another embodiment, the drone 11 can use the propeller motors 13B to connect to a small dynamo, which is a machine for converting mechanical energy into electrical energy, or to a small electric generator (not shown in FIGS. 3A-3K). For this alternative embodiment the propeller motors 13B must have shafts exiting on both ends, with the upper shaft being connected to the actual propeller 13A and the opposite lower shaft to be connected to the dynamo/generator. In this way the dynamos/generators can re-charge the batteries of the battery block 23 during the flight or operation time of the drone 11, by transforming the rotational movement produced by propeller motors 13B into electricity. Thus, the life of the battery block 23 of the drone 11 can be extended with beneficial effects on continuity and efficiency of the inspection or cleaning operations.

In another embodiment, the life of the battery block 23 can be extended if the drone 11 has a mini-solar panel attached on its top (not shown in FIGS. 3A-3K), which can collect energy from the sun during the inspection and/or cleaning process and thus allows a longer flight time for the drone 11. In other situation the thrust from the propeller assembly 13 can create air movement that can be captured by a mini-turbine attached to the drone 11 (not shown in FIGS. 3A-3K) that can generate energy and thus additionally charges the battery block 23 during flight, which will allow a longer flight time for the drone 11.

For the drone cleaning system 30 with dedicated air blower presented in FIGS. 3A-3K, to properly function needs the attached elements to the drone 11, as the sustaining platform 31, blower fan motor 32, blower fan 33, duct system 18, and nozzle 19 to create the air flow and the conduit to allow the actual cleaning using jets of air coming out of the nozzle 19. The weight of the cumulated elements 31, 32, 33, 18, and 19 it is an important factor that can limit the performance of the drone cleaning system 30 with dedicated air blower. The higher weight will temper with the drone 11 capability to lift up, to fly, and with the flight time, since larger weights reduces the actual life of the battery blocks 23 used to power the drones 11. This is why it is important that the total weight of the cumulated elements 31, 32, 33, 18, and 19 preferably is in between 1.5 to 4.5 kilograms for allowing an optimum operation of the drone 11.

For this embodiment, as mentioned before, the materials used for the duct system 18 and nozzle 19, are preferably light to make it easy for the drone to fly and to not consume unreasonably the power of the battery block 23, due to excessive weight. Preferably, the material is a light plastic or a rigidized and rubberized light cloth material or a strong water proof and rigidized light paper material. When made of plastic, the actual duct system 18 and nozzle 19 can be manufactured via an injection molding process or 3D-printed. The duct system 18 and nozzle 19 can be independent parts that are assembled together or can be produced, molded, or 3D printed as one integral assembly.

As mentioned before for the embodiment presented in FIGS. 1A-1E, 2A-2E, for the embodiment presented in FIGS. 3A-3K the operator is using the cleaning system controller 50 (see FIG. 5) to control from the ground the whole activity of the drone 11 and of the of the drone cleaning system 30 with dedicated air blower. The reception of commands from the cleaning system controller 50 to the drone 11 is done via the WiFi antenna 35 and the instantaneous position of the drone 11 is all the time indicated and communicated in between the cleaning system controller 50 and the drone 11 via the GPS antenna 36, which allows the human operator to make any decisions to correct the drone 11 position, if necessary. Thus, the drone 11 can be moved in the drone movement directions 20 (vertical, longitudinal or rotational) to be able to be positioned correctly relatively to the targeted structure surface 22 that needs inspection and/or cleaning.

As mentioned before for the embodiment presented in FIGS. 1A-1E, 2A-2E, for the embodiment presented in FIGS. 3A-3K the nozzle 19 is also designed to collect the air coming from the duct system 18 at a certain velocity. By changing its geometry from round cross-section to a rectangular smaller output cross-section, the nozzle 19 is able to speed up the air and thus creating a more powerful drone blowing force 21, to increase the efficiency of the targeted structure surface 22 cleaning. If the duct system 18 has a cross-section different from round, then the nozzle 19 geometry is built in such way to significantly reduce the cross-section dimension from the dimensions of the duct system 18 to much lower dimensions at the opening of the nozzle 19, in order to increase the velocity of the air at its exit from nozzle 19. In embodiments, where fluids are added to the air stream (see FIGS. 3F-3K), the same principle applies to increase velocity of the air/fluid mixture. A much lower opening at the exit from nozzle 19 besides increasing air or air/fluid velocity it also helps with concentrated the jet of air or air/fluid mixture and drone blowing force 21 on a smaller area of the targeted structure surface 22 and thus increasing its cleaning efficiency of the material deposit and fouling organisms 24 (see FIGS. 3C and 3G). Furthermore, the nozzle design presented in FIG. 4 also applies for the embodiment presented in FIGS. 3A-3E, which can be used to increase the drone blowing force 21 and finally the cleaning efficiency of the drone cleaning system 30 with dedicated air blower.

If the drone system can lift larger weights, then the drone 11 can have special attached elements that are capable of injecting fluid in the air stream or use other energy devices, which can enhance the cleaning effect. This is presented for the drone cleaning system 30 with dedicated air blower in FIGS. 3F-3K. The fluid can be water by itself or mixed with biocides, active detergents, cleaning substances, or special chemicals, which are environmentally friendly and are dissolved in the respective fluid, creating different mixtures that are used for removing stains, molds, mildew, fungi, algae, biofilms, etc. To enhance cleaning with different drone cleaning systems, energy devices 29A can be attached to the duct system 18 or to the nozzle 19. Some of the energy devices 29A preferable used are ultrasound piezo-crystals that produce ultrasound or sound waves or shock waves transmitted through the liquid mist expelled from nozzle 19, or photodevices as lasers, or infrared-light LEDs (light emitting diodes)/OLEDs (organic light emitting diodes), or ultraviolet light lamps, etc., as presented in detail in FIGS. 3F-3K. In FIGS. 3F-3K, for clarity in showing new elements and avoiding confusion, the camera 14 (presented before in FIGS. 1A-1E, 2A-2E, and 3A-3E) was removed.

As presented in the embodiments from FIGS. 3F-3K, if the drone 11 is capable of heavy lifting, then a fluid reservoir 37 can be mounted on the drone. When needed, the fluid reservoir 37 will release gravitationally the fluid (pressurized or non-pressurized) via a fluid pump 38 and flexible fluid tubing 39 to the nozzle 19, although in other embodiments the flexible fluid tubing 39 can be connected to the duct system 18. In this way the pumped fluid will mix with the pressurized air from the duct system 18 and nozzle 19, and create a pressurized liquid mist 29D that could enhance the cleaning of and removing of stains or unwanted material deposit and soiling/fouling organisms 24, but also producing the disintegration and killing of molds, mildew, fungi, algae, or bacterial biofilms from the targeted structure surface 22, when biocides, active detergents, cleaning substances, or special chemicals, which are environmentally friendly and are dissolved in the respective fluid. The fluid reservoir 37 is filled with the appropriate fluid by the drone operator when the drone 11 is on the ground.

To enhance even more the cleaning of and removing of stains or unwanted material deposit and soiling/fouling organisms 24 from the targeted structure surface 22, energy devices 29A can be attached to the duct system 18 or to the nozzle 19, as presented in detail in FIGS. 3F, 3G, 3H, 3I, and 3J. For this embodiment, the electricity to activate the energy devices 29A is collected from the battery block 23 via the electrical cable 28 (see FIGS. 3G, 3H and 3K). In order for the energy devices 29A to correctly function and properly transmit ultrasound or sound waves or shock waves 29E towards the targeted structure surface 22, a pressurized liquid mist 29D (see FIG. 3G) is needed that is formed by the mixture of air flow and a liquid provided by the fluid reservoir 27, via fluid pump 38 and fluid tubing 39. The combination of pressurized liquid mist 29D with the ultrasound or sound waves or shock waves 29E, produced by the energy device 29A, increases the drone blowing force 21, which further enhance the cleaning of and removing of stains or unwanted material deposit and soiling/fouling organisms 24 from the targeted structure surface 22.

As presented in detail in FIG. 3I, to produce ultrasound or sound waves or shock waves 29E, the energy device 29A is in the form of ultrasound or sound wave or shockwave piezoelectric nozzle 29B, which is placed at the distal end of the nozzle 19, forcing the pressurized liquid mist 29D to exit through the ultrasound or sound wave or shockwave nozzle opening 29C. In this way the pressurized liquid mist 29D becomes the carrier of the ultrasound or sound waves or shock waves 29E towards the unwanted material deposit and soiling/fouling organisms 24 from the targeted structure surface 22. Due to small round dimension of the ultrasound or sound wave or shockwave nozzle opening 29C, the pressurized liquid mist 29D accelerates even more, when compared to a larger rectangular opening of the nozzle 19 as seen in the embodiments from FIGS. 1A-1E, 2A-2E, and 3A-3E. The additional acceleration of the pressurized liquid mist 29D can generate an even larger drone blowing force 21. In this way with the embodiment presented in FIG. 3I, the drone blowing force 21 is increased by the higher velocity of the pressurized liquid mist 29D coming out of the ultrasound or sound wave or shockwave piezoelectric nozzle 29B and concomitantly by the addition of ultrasound or sound waves or shock waves 29E to the pressurized liquid mist 29D.

In the embodiment from FIG. 3J, an even more sophisticated energy device 29A is presented. In this case, the energy device 29A is designed to contain besides a small rectangular ultrasound or sound wave or shockwave piezoelectric nozzle 29B also multiple lasers or infrared-light LEDs (light emitting diodes)/OLEDs (organic light emitting diodes) or ultraviolet light lamps 29F distributed uniformly above and below the ultrasound or sound wave or shockwave piezoelectric nozzle 29B. The multiple lasers or infrared-light LEDs/OLEDs or ultraviolet light lamps 29F will contribute to the destruction/killing of molds, mildew, fungi, algae, or bacterial biofilms (organic fouling material) from the targeted structure surface 22. Based on how heavy are the deposits of the organic fouling material from the targeted structure surface 22, the multiple lasers or infrared-light LEDs/OLEDs or ultraviolet light lamps 29F, can be activated independently or concomitantly with the ultrasound or sound wave or shockwave piezoelectric nozzle 29B.

The operator can choose at her/his discretion the use of different modalities that are available for removal unwanted deposits or destruction of the organic fouling material (molds, mildew, fungi, algae, or bacterial biofilms). When only material deposits are present without any visible organic fouling material, the operator may use only the air flow ejected from the nozzle 19. In the case when the amount of material deposits is large and stains are also present, the operator can activate the dispensing of the fluid, to create a pressurized liquid mist 29D, which might enhance the cleaning efficiency. Furthermore, in situations when large amounts of unwanted material deposit and soiling/fouling organisms 24 are present, the operator can activate besides the air flow and dispensing of fluid also the ultrasound or sound wave or shockwave piezoelectric nozzle 29B to produce ultrasound or sound waves or shock waves 29E that are carried concomitantly via the pressurized liquid mist 29D towards the targeted structure surface 22. As the ultimate super action can be achieved by activating as well the lasers or infrared-light LEDs/OLEDs or ultraviolet light lamps 29F, which will help with the destruction and removal of significant organic fouling material present on a specific targeted structure surface 22.

Elements as the electrical cable 28 for the energy devices 29A, ultrasound or sound waves or shockwave piezoelectric nozzle 29B, lasers or infrared-light LEDs (light emitting diodes)/OLEDs (organic light emitting diodes) or ultraviolet light lamps 29F, fluid reservoir 37, fluid pump 38, and fluid tubing 39, as presented in FIGS. 3F-3K, can be also implemented for the embodiments presented in FIGS. 1A-1E, 2A-2E, which increases their versality and efficiency.

If the drone 11 is powerful or big enough to create a significant thrust or is specially designed to carry heavy weights, then it is possible to have an alternative embodiment with a very long hose that connects directly to the nozzle 19 to direct air from an air compressor set on the ground, which is controlled by the operator of the drone 11. In this way the pressurized air needed for cleaning of a targeted structure surface 22 can be applied from the hose without heavy attachments/elements presented in embodiments from FIGS. 1A-1E, 2A-2E, 3A-3E, which were needed to be attached to the drone 11. To reduce the weight of the hoses used for this embodiment, the hose material can be very light and can be made of silk or cloth material, which also allows to create a “collapsible” hose when not used. Thus, the round section, necessary to transmit the compressed air from the air compressor to the nozzle 19 from the flying drone 11, will become completely flat when no air flows through it, which will help with reducing the space necessary to store the hose during transportation from one cleaning site to another. Depending on the complexity of the building/structure that needs cleaning, the length of the hose preferably is enough to reach the targeted structure surface 22 and in the same time avoiding entanglements. Recommended length of the hose preferably is in between 30 to 100 meters. That might bring limitations for such an embodiment, but those limitations can be overcome by its advantages, which are higher drone blowing force 21, possibility of mixing the air with biocides (fluid or powder) to kill molds, mildew, fungi, algae, or bacterial biofilms from the targeted structure surface 22.

If the air compressor is replaced by a liquid pump and if the drone 11 is powerful or big enough to create a significant thrust or is specially designed to carry heavy weights, then liquids may also be pumped through the above-mentioned light weight and collapsible hoses, which in some cases may give more cleaning power and efficiency for the respective embodiments. Of course, this embodiment will allow mixtures of fluids with biocides to not only clean the targeted structure surface 22, but also to kill bacterial biofilms, molds, mildew, fungi, or algae deposits from the targeted structure surface 22. In this embodiment, energy devices 29A can be attached to the duct system 18 to enhance cleaning. Some of the energy devices preferable used are the ultrasound or sound wave or shockwave piezoelectric nozzle 29B that uses piezo crystals to produce ultrasound or sound waves or shock waves 29E transmitted through the pressurized liquid mist 29D expelled from nozzle 19, or photodevices as lasers, or infrared-light LEDs/OLEDs, or ultraviolet light lamps 29F, etc. This approach can be applied to any of the embodiments presented in FIGS. 1A-1E, 2A-2E, 3A-3E.

The embodiments of the drone cleaning system 30 with dedicated air blower presented in FIGS. 3A-3K can be used to clean gutters, historic buildings, monuments, silos, tall buildings and high rises, bridges, dams, solar panels, solar roof tiles, mirrors for solar ray water heating systems, large satellite dishes or telescopes, gondola lifts, billboards and large signs, different industrial or commercial or community tall structures (utility power plant chimneys, paper mill stacks, industrial chimney cleaning, marine smokestacks, rigging and lifting, bridges, dams, lighthouses, radio towers, landmark signage, large wind power turbines, and church steeples), large aircrafts and ships, space crafts or rockets and launching pads, busses and large trucks, large earth-moving equipment, elevator shafts, large pipes and ducts, mine shafts, large storage containers (water, oil, chemicals, etc.), shipping containers, stadiums or sport venues on the inside and outside, special large roofs, the inside of buildings or theaters or museums that have large atriums, and other similar structures to name a few. Similarly, the drone cleaning system 30 with dedicated air blower presented in FIGS. 3A-3K can be used to blow objects (in air, on land or on water), debris (in air, on land or on water), substances (in air, on land or on water), or materials floating on water (e.g., lakes, rivers, ocean and like bodies).

The embodiments presented in FIGS. 1A-1E, 2A, 2B-2E, 3A-3K generate sufficient drone blowing force 21 to produce a thorough cleaning while avoiding material damage to the targeted structure surface 22. The control of the drone blowing force 21 can be done via the total number of full air thrust collection funnels 17 for the embodiment presented in FIGS. 1A-1E, the total number of partial air thrust collection funnels 26 for the embodiment presented in FIGS. 2A-2E, and by adjusting the rotational speed of the blower fan motor 32 for the embodiment presented in FIGS. 3A-3K.

It is important to note that the position of targeted structure surface 22 from which the material deposit and fouling organisms 24 is cleaned can be horizontal (see FIG. 1C), vertical (see FIG. 2C and FIG. 3G), or at an angle (see FIG. 3C) relatively to the drone 11 hovering position. This means that the embodiments presented in FIGS. 1A-1E, 2A-2E, 3A-3K are capable to clean any type of material deposit and fouling organisms 24 form a targeted structure surface 22, regardless of the orientation and intricacies of the targeted structure surface 22. Also, due to gentleness of the cleaning produced by the embodiments from FIGS. 1A-1E, 2A-2E, 3A-3K, a thorough cleaning action while avoiding material damage can be done for any possible material and surface finish of the targeted structure surface 22.

The embodiments presented in FIGS. 1A-1E, 2A-2E, 3A-3E that are able to use drones and also use different fluids injected by a pump from the ground can be also used to spray insecticides in trees or high buildings to kill weeds, kudzu, ivy, or different parasites. Similarly, sealants, roof/building chemical patching like spray foams, fillers, etc. can be delivered where they are needed using drones 11 with the specially designed attachments that are connected to a hose linked with a pump on the ground. In these cases, the chemicals are mixed in containers placed on the ground by the drone 11 operator, who also connects the light and collapsible hose to the drone. Afterwards, the drone operator safely operates the flight of the drone 11 towards the targeted structure surface 22 or trees or organic plants that require treatment, during the actual treatments, and finally on the returning flight towards the base from which the operator controls all the process. The containers, pumps, or compressors have wheels and have a manageable weight, which makes them mobile and allow a comfortable mobility when performed by a normal strength operator.

The desired functionality of the embodiments presented in FIGS. 1A-1E, 2A-2E, 3A-3K, to produce a jet of air or air/fluid towards a surface that needs gentle cleaning while avoiding material damage, is dictated by the cleaning system controller 50 and drone 11 internal hardware structures presented in FIG. 5. Each of the components presented in FIG. 5 may include hardware, software, or a combination of hardware and software configured to perform one or more functions associated with providing good functioning. The one or more components may be coupled by optical, electrical, wireline or wireless media.

Thus, the cleaning system controller 50 includes as main components the unit processor or microcontroller module 51, the joysticks module 54, ON/OFF switch module 59, camera control module 61, and the display module 63. By using these five main modules the cleaning system controller 50 is able to correctly control all activities performed by the drone 11. The main components of the drone 11 are the drone WiFi module 64, the drone GPS (Global Positioning System) module 65, the drone electronics 15, the propeller assembly module 66, the blower fan motor 32 (for embodiment from FIGS. 3A-3K), camera 14, sensors module 67, and other devices module 68 for connectivity and control of other devices or accessories used with the drone 11, as energy devices 29A, ultrasound or sound waves or shockwave piezoelectric nozzle 29B, lasers or infrared-light LEDs (light emitting diodes)/OLEDs (organic light emitting diodes) or ultraviolet light lamps 29F, fluid pump 38, as presented in FIGS. 3F-3K. All the transmissions from the cleaning system controller 50 towards the drone 11 are done from different modules and submodules of the cleaning system controller 50 via unit processor or microcontroller module 51 and its controller WiFi submodule 52 and drone WiFi module 64 that connects/activates/gets feedback from the drone electronics 15 present on the drone 11, as indicated by solid arrows throughout FIG. 5. On its turn, the drone electronics 15 activates and gets feedback from all the modules present on the drone 11 and that is also indicated by the solid arrows seen inside the drone 11 box. The dashed line arrows from FIG. 5 are used only to indicate the final inter-relationship of different modules and submodules from the cleaning system controller 50 and drone 11, and does not have anything in common with the actual control command pathway. In general, the cleaning system controller 50 dictates, gets feedback and controls the functionality of the drones 11 and their sub-devices/components that are incorporated in all embodiments presented in this patent, which creates a master-slave electronic relationship.

The ON/OFF switch module 59 from FIG. 5 is used to turn “ON” or “OFF” the cleaning system controller 50, respectively the drones 11, and internal functions or components incorporated into the cleaning system controller 50 and drones 11 from the embodiments presented in FIGS. 1A-1E, 2A-2E, 3A-3K.

For the embodiment presented in FIGS. 3A-3K the ON/OFF switch module 59 is also controlling the blower fan motor 32 and consequently the blower fan 33. In this particular situation, the ON/OFF switch module 59 is using the interconnected blower control submodule 60 incorporated into the cleaning system controller 50, to turn ON or OFF the blower fan motor 32 and get feedback regarding the functionality (rotational speed) of the blower fan motor 32 attached to drone 11. Similarly, the ON/OFF switch module 59 can control the activation of the fluid pump 38 or of the energy devices 29A. After activation produced by the ON/OFF switch module 59, the transmission of commands is done via unit processor or microcontroller module 51 that activates the controller WiFi submodule 52, which initiates the WiFi communication using the WiFi antenna 35 from drone 11. The information and commands transmitted through WiFi antenna 35 to the drone 11 activate the drone WiFi module 64, which at its turn connects with drone electronics 15 and finally generates electrical signals to control the blower fan motor 32 or the other devices module 68. The dashed line in between blower control submodule 60 from cleaning system controller 50 and the blower fan motor 32 from drone 11 or from the other devices module 48 of drone 11 to the cleaning system controller 50, where the ON/OFF switch module 59 is included, shows their final inter-relationship only and do not depicts the actual pathway for transmission of signals and commands.

The unit processor or microcontroller module 51 from FIG. 5 is the main component of the cleaning system controller 50 since is controlling the functionality and produces microprocessor-executable instructions/commands for all the other modules and submodules of the cleaning system controller 50 and drones 11 from the embodiments presented in FIGS. 1A-1E, 2A-2E, 3A-3K. The microcontroller module 51 is activated by the ON/OFF switch module 59 and after that takes control over all operations and existing modules and submodules from both cleaning system controller 50 and drone 11. Thus, the processor or microcontroller module 51 is receiving and transmits information (including functionality feedback) from/to joysticks module 54, camera control module 61, and display module 63 of the cleaning system controller 50. Through the WiFi submodule 52, the unit processor or microcontroller module 51 initiates the WiFi communication in between the cleaning system controller 50 and drone 11 using the WiFi antennas 35 from the drones 11. Furthermore, the controller GPS (Global Positioning System) submodule 53 is activated by the processor or microcontroller module 51 and directly communicates via the GPS antenna 36 from the drone 11 with the corresponding drone GPS (Global Positioning System) module 65. The controller GPS submodule 53 and drone GPS module 65 are necessary to correctly control the positioning of the drones 11 relatively to the operator position and relatively to the targeted structure surface 22. The WiFi antenna 35 and GPS antenna 36, when they receive the WiFi signal from the cleaning system controller 50 activate the drone WiFi module 64 and the drone GPS module 65, which at their turn connect with drone electronics 15, which finally generates electrical signals to control, receive feedback, and activate all the modules and components present on the drone 11, which are the WiFi module 64, the drone GPS (Global Positioning System) module 65, the propeller assembly module 66, the blower fan motor 32 (for embodiment from FIGS. 3A-3K), camera 14, sensors module 67, and other devices module 68.

The joysticks module 54 from FIG. 5 includes one or more actual joysticks that are used to control the movements of drones 11 from the embodiments presented in FIGS. 1A-1E, 2A-2E, 3A-3K, via unit processor or microcontroller module 51 from the cleaning system controller 50. The joysticks module 54 in fact controls the vertical lift of the drones 11 via the vertical lift submodule 55, the horizontal and lateral linear movements of the drones 11 via the XY movement submodule 56, rotation speed of propeller assemblies 13 from the drones 11 via the propeller assembly rotation per minute (RPM) submodule 57, and rotational movement of the drones 11 via the rotation submodule 58. All these submodules, present on the cleaning system controller 50, transmit functionality internal signals via the joystick module 54 to the unit processor or microcontroller module 51, which at its turn using the WiFi submodule 52, the WiFi connection, the WiFi antenna 35 (described previously in detail elsewhere), and the drone WiFi module 64 sends commands and receives functionality feedback to/from the propeller assembly module 66 of the drones 11 that includes multiple propeller assemblies 13, as dictated by the specific construction of the drones 11. In this way the movements of the drones 11 are meticulously performed by controlling the functionality parameters of propeller assemblies 13, which allows the human operator by means of the cleaning system controller 50 to properly control the efficient cleaning of the targeted structure surface 22 using the embodiments presented in FIGS. 1A-1E, 2A-2E, 3A-3K.

The camera control module 61 from FIG. 5 is used to control the movements of cameras 14, placed on the drones 11 from the embodiments presented in FIGS. 1A—1E, 2A-2E, 3A-3K, via unit processor or microcontroller module 51 from the cleaning system controller 50. The camera control module 61 in fact controls all the movements of camera 14 from the drone 11, to provide proper live images during inspection or cleaning process to the human operator sitting on the ground, while the drone 11 flies up and down, across, or around the targeted structure surface 22 that needs inspection or cleaning. To accomplish that the camera 14 from the drone 11 preferably is able to perform rotational and/or swiveling movements to provide the proper field of view for the operator, via the display module 63, which is done via rotation/pan submodule 62 that is directly connected with the camera control module 61. The actual commands from rotation/pan submodule 62 are transmitted as functionality internal signals to the camera control module 61 and to the unit processor or microcontroller module 51, which at its turn using the t the WiFi submodule 52, the WiFi connection, the WiFi antenna 35, and the drone WiFi module 64 sends commands and receives functionality feedback to/from the camera 14 of the drone 11 via drone electronics 15, using the same WiFi pathway and WiFi antenna 35. The proper functionality feedback about camera 14 movements is transmitted backwards via the same pathway to the camera control 61 and its associated rotation/pan submodule 60. In this way the movements of the camera 14 are meticulously performed, which allows the human operator, by means of the cleaning system controller 50, to properly assess via live visual feedback the efficient inspection and/or cleaning of the targeted structure surface 22. The live visual feedback to the human operator allows the proper adjustment and control of the drone 11 and its internal components during inspection and/or cleaning operation of the targeted structure surface 22 for the embodiments presented in FIGS. 1A-1E, 2A-2E, 3A-3K.

The display module 63 from FIG. 5 is used to show live images to the human operator from the cameras 14, placed on the drones 11 from the embodiments presented in FIGS. 1A-1E, 2A-2E, 3A-3K. The unit processor or microcontroller module 51 from the cleaning system controller 50 provide the input and output information together with functionality feedback to the display module 63, in order to be displayed to the human operator. Consequently, the sensor module 67 and other devices module 68 from the drones 11 will provide information and functionality feedback to the display module 63 to be shown to the human operator, via unit processor or microcontroller module 51 and the same WiFi pathway and WiFi antenna 35, described previously in detail elsewhere. In similar way, the display module 63 may receive information to be displayed to the human operator from the joysticks module 54 regarding the drone 11 movements, or from the ON/OFF switch module 59 regarding the ON/OFF state of different components and modules of both cleaning system controller 50 and drones 11, or from the camera control module 61 regarding the actual movements and positioning of the camera 14 from drone 11, or from the processor or microcontroller module 51 regarding state of functional parameters from both cleaning system controller 50 and drones 11. Also, the positioning of the drone 11 is transmitted from the drone GPS module 65, via the GPS antenna 36 to the controller GPS submodule 53 and through the unit processor or microcontroller module 51 to the display module 63, to show continuously to the human operator the position coordinates of the drone 11. The display to the human operator of live visual images from camera 14 or of any functional parameters from both cleaning system controller 50 and drone 11, allows the proper adjustment and control of the drone 11 and its internal components during inspection and/or cleaning operation of the targeted structure surface 22 for the embodiments presented in FIGS. 1A-1E, 2A-2E, 3A-3K.

The sensors module 67 from the drones 11 from FIG. 5 contain multiple collision sensors to avoid any contact with the targeted structure surface 22 during inspection and/or cleaning processes using the embodiments presented in FIGS. 1A—1E, 2A-2E, 3A-3K and thus eliminate any potential damage to the targeted structure surface 22. In this way the whole inspection and/or cleaning operation can be made in a safer way and shorter time. Furthermore, the same sensors module 67 allows the flying of the drone towards the targeted structure surface 22, without bumping in human beings, other structures from around the targeted structure surface 22, or any natural obstacles present in between the human operator/ground positioning from where the drone 11 started flying and the targeted structure surface 22. Similarly, after the drones 11 of the embodiments presented in FIGS. 1A-1E, 2A-2E, 3A-3K finished their inspection and/or cleaning process, when returning from the targeted structure surface 22 back to the human operator and the landing site, they need to avoid structures, natural obstacles, and human beings, which is also done via the inputs and feedback from the sensors module 67.

The role of the other devices module 68 from FIG. 5 has the role to allow the drones 11 of the embodiments presented in FIGS. 1A-1E, 2A-2E, 3A-3K, to accommodate elements/components as the energy devices 29A, ultrasound or sound waves or shockwave piezoelectric nozzle 29B, lasers or infrared-light LEDs/OLEDs or ultraviolet light lamps 29F, fluid pumps 38, as presented in FIGS. 3F-3K, or future plug and play devices or components, as additional cameras 14, extra battery blocks 23, additional motors to allow the movement of a possible hinged duct system 18 or of a possible hinged nozzle 19 (not particularly shown in any of the figures), etc., all being elements/components needed for enhancing the cleaning process of a targeted structure surface 22.

Besides the WiFi communication described in detail, drones 11 and the cleaning system controller 50 can also employ other communication means in between their different components as Bluetooth or RFID that can be present depending on specific needs.

In some embodiments applicable to the FIGS. 1A-1E, 2A-2E, 3A-3K, an external information storage device (not shown in any of the figures) can be in the form of an RFID system that may be used to communicate with the cleaning system controller 50 to store/or read functionality information about the cleaning process that can be later used as proof of task execution and ultimately linked with the billing of the customer. In various embodiments, the RFID external treatment information storage device may be a tag, label, or chip, and may include passive, active or semi-passive technology. In other embodiments, the RFID device may include RFID chip-less technology or electronic product code technology. Chipless RFID devices may allow for discrete identification of RFID tags without an integrated circuit, thereby allowing tags to be printed directly onto the surface of a tag or label that contains info about actual or previous services performed to a specific customer. In other situations, the RFID information storage device may be a passive RFID tag that requires no electrical supply for powering the tag. In various embodiments, an RFID device may communicate according to the International Standards Organization (“ISO”) 14443 and/or the International Electrotechnical Commission (“IEC”) 18000-6 standards. The RFID storage device may communicate up to a distance of 10 cm (i.e., 4 inches) from the cleaning system controller 50, in accordance with ISO 14443. The RFID device may be included in a smart label governed by ISO 15693.

In some instances, in order to charge the customer for the services performed with the embodiments from FIGS. 1A-1E, 2A-2E, 3A-3K an external system/device with the cost information scheme based on usage time during inspection and/or cleaning, which can be in the form of an RFID tag, a label or chip, memory stick, smart card, credit card, barcode, floppy disk, CD-ROM, digital versatile disk (“DVD”) or any device configured to store information and from which the cost information may be read directly by the cleaning system controller 50, described in detail in FIG. 5.

The inventions described herein are not intended to be limited to specific embodiments that are provided by way of example, but extend to the full scope of such claims of a corresponding issued patent.

What is claimed is:

1. An apparatus comprising:
an unmanned drone aircraft having a plurality of propellers;
an air duct that terminates at a blower nozzle coupled to the drone aircraft, wherein the air duct is positioned and configured to receive air flow generated during flight of the aircraft and emit a jet of air with a blowing force from the blower nozzle.

2. The apparatus of claim 1, further comprising a funnel adjacent a propeller and connected to the air duct to provide an air flow channel.

3. The apparatus of claim 2, further comprising two or more funnels each adjacent to a respective propeller and each connected to the air duct to provide an air flow channel.

4. The apparatus of claim 2, wherein the propeller adjacent the funnel has a propeller length, the funnel has an opening with a perimeter or circumference, and the propeller length fits entirely within the dimensions of the perimeter or circumference of the opening.

5. The apparatus of claim 3, wherein each propeller adjacent a funnel has a propeller length, each funnel has an opening with a perimeter or circumference, and each propeller length of a respective propeller adjacent a funnel fits entirely within the dimensions of the perimeter or circumference of the opening adjacent the respective propeller.

6. The apparatus of claim 1, further comprising a collision sensor coupled to the drone aircraft.

7. The apparatus of claim 1, further comprising an energy device coupled to at least one of the nozzle and air duct that generates at least one of ultrasound, sound waves and shock waves.

8. The apparatus of claim 7, further comprising a fluid pump coupled to the drone aircraft and configured to provide a liquid mist adjacent the energy device for transmitting the at least one of ultrasound, sound waves and shock waves.

9. The apparatus of claim 8, wherein the energy device coupled to at least one of the nozzle and air duct that includes at least one of a laser, light emitting diode configured to produce infrared light, organic light emitting diode configured to produce infrared light, and an ultraviolet light source.

10. The apparatus of claim 1, further comprising an energy device coupled to at least one of the nozzle and air duct that includes at least one of a laser, light emitting diode configured to produce infrared light, organic light emitting diode configured to produce infrared light, and an ultraviolet light source.

11. The apparatus of claim 1, further comprising a blower motor and blower fan coupled to the air duct.

12. The apparatus of claim 11, wherein the one or more propellers are positioned at a top of the drone aircraft and the blower motor and blower fan are positioned at an opposite bottom of the drone aircraft.

13. The apparatus of claim 12, further comprising an energy device coupled to at least one of the nozzle and air duct that includes at least one of a laser, light emitting diode configured to produce infrared light, organic light emitting diode configured to produce infrared light, and an ultraviolet light source.

14. The apparatus of claim 11, further comprising an energy device coupled to at least one of the nozzle and air duct that includes at least one of a laser, light emitting diode configured to produce infrared light, organic light emitting diode configured to produce infrared light, and an ultraviolet light source.

15. The apparatus of claim 14, further comprising a fluid pump coupled to the drone aircraft and configured to provide a liquid mist adjacent the energy device for transmitting the at least one of ultrasound, sound waves and shock waves.

16. The apparatus of claim 11, further comprising an energy device coupled to at least one of the nozzle and air duct that generates at least one of ultrasound, sound waves and shock waves.

17. The apparatus of claim 16, further comprising a fluid pump coupled to the drone aircraft and configured to provide a liquid mist adjacent the energy device for transmitting the at least one of ultrasound, sound waves and shock waves.

18. A method of cleaning a structure comprising positioning the apparatus of claim 1 near a targeted surface of said structure and blowing a jet of air sufficient to remove unwanted material from the targeted surface.

19. The method of claim 18, wherein the structure is selected from the group consisting of a residential building gutters, historic buildings, monuments, silos, tall buildings and high rises, bridges, dams, church steeples, radio towers, solar panels, solar roof tiles, mirrors for solar ray water heating systems, large satellite dishes or telescopes, gondola lifts, billboards and large signs, utility power plant chimneys, paper mill stacks, industrial chimney cleaning, marine smokestacks, rigging and lifting, bridges, dams, lighthouses, landmark signage, large wind power turbines, large aircrafts and ships, space crafts or rockets and launching pads, busses and large trucks, large earth-moving equipment, elevator shafts, large pipes and ducts, mine shafts, large storage containers, shipping containers, stadiums or sport venues on the inside and outside, special large roofs, and inside of buildings or theaters or museums that have large atriums.

20. A method comprising blowing at least one of an object, debris, substance, and material floating on water with the apparatus of claim 1.
